(19) United States
(12) Patent Application Publication
(10) Pub. No.: US 2024/0084503 A1
(43) Pub. Date: Mar. 14, 2024

(54) CELLULASE-CONTAINING COMPOSITION, USE THEREOF AND METHOD FOR RESTORING OF USED GARMENTS

(71) Applicant: BIO RESTORE AB, Täby (SE)

(72) Inventor: Wajahat HUSSAIN, Täby (SE)

(21) Appl. No.: 18/272,485

(22) PCT Filed: Jan. 14, 2022
(86) PCT No.: PCT/EP2022/050762

§ 371 Date: Jul. 14, 2023

(30) Foreign Application Priority Data
Jan. 15, 2021 (SE) 2150033-5

(51) Int. Cl. D06M 16/00; C11D 1/835; C11D 3/04; C11D 3/20; C11D 3/386; C11D 11/00; C11D 17/06; D06M 11/56; D06M 13/165; D06M 13/192; D06M 13/207; D06M 15/11

(52) U.S. Cl. CPC D06M 16/003; C11D 1/835; C11D 3/046; C11D 3/2079; C11D 3/2082; C11D 3/2086; C11D 3/38645; C11D 11/0017; C11D 17/06; C12Y 302/01004; C12Y 302/01021; C12Y 302/01091; D06M 11/56; D06M 13/165; D06M 13/192; D06M 13/207; D06M 15/11; D06M 2101/06

(57) ABSTRACT

The present disclosure is directed to use of a composition for restoring of a cellulose-containing used garment in a non-industrial laundry equipment selected from a domestic laundry equipment and a professional non-industrial equipment, wherein the composition comprises from about 15% to about 60% of a cellulase preparation, wherein the restoring is selected from a group consisting of: (i) restoring of a mechanical tension of the garment, thereby achieving a re-shaping of the garment, (ii) de-pilling of a surface of the garment, and (iii) de-fraying of a collar(s) and/or edge(s) of the garment, and any combinations thereof. Also disclosed are compositions for use in restoration of a cellulose-containing used garment and methods for restoring a cellulose-containing used garment in a non-industrial laundry equipment selected from a domestic laundry equipment and a professional non-industrial equipment.

### FIELD OF THE DISCLOSURE

The present disclosure relates to the restoration of used garments, wherein the restoration for example may comprise de-pilling of the surface of the garment, de-fraying of collars and edges, restoring the mechanical tension of the garment, and any combinations thereof. More particularly, compositions comprising cellulase are disclosed, which may be used for restoring of cellulose-containing used garments in a non-industrial setting. Use of a composition comprising cellulase and methods for restoring of cellulose-containing used garments in a non-industrial setting are also disclosed.

### BACKGROUND OF THE DISCLOSURE

Cellulase is a general term for a group of enzymes that hydrolyse the b-(1,4)-linkages in cellulose. A previously known use of cellulase enzymes for textiles is the industrial pre-treatment processes for removal of hairiness before dyeing or at the finishing stage during the industrial production of new textiles (see e.g., U.S. Pat. No. 6,268,196).

The second major known use of cellulase in relation to textiles and garments is as a cleaning aid in detergents. A detergent is a chemical composition that removes dirt from soiled textiles and garments. The primary purpose of using enzymes in detergency is to catalyze breakdown of protein- or carbohydrate-based stains to facilitate the removal by surfactant and builder, i.e., the cellulase use in detergents is designed for optimizing the cleaning impact. Cellulase-containing detergents are for example described in WO92/06165, U.S. Pat. Nos. 5,120,463, and 5,904,736.

Whenever a new garment is purchased it has gone through a series of production processes that optimize a garment's serviceable features like surface appearance, tactility, colour, fitting etc. These elements constitute the attributes that are important for a garment to be considered new. Once a garment has been bought, after being used for some time, the garment goes through a wearing process which includes being subjected to a multitude of physical and chemical stresses such as bending, compression, laundering, and abrasion forces along with stretching. All these factors lead to fatigue and wear and change in fabric properties, to a point where the garment is no longer usable either because of its physical shape or because of losing key aesthetical attributes like reflectance, newness, softness, and the clean look that was once there at the time of shopping. The changes in surface appearance include formation of pills, fraying caused by abrasion of the fabric due to rubbing with external surfaces or body parts, and ultra-structural changes caused by laundering and use, especially in cellulose-containing garments. Loss of shape is due to pilling and fibrillation. Colour and print fading perception is due to low reflectance caused by shadow formation. These changes, due to the nature of the cellulosic material, construction of the garment, and end use are unavoidable. Consequently, garments are discarded by consumers, which is a waste of resources and leads to the accumulation of textile waste in landfills. A process for rejuvenating fabrics comprising contacting fabrics with an enzyme and subsequently contacting said fabric with an enzyme inhibitor has been described in EP1090980.

However, it would be desirable to enable consumers to obtain an efficient recovery of the lost attributes of newness at home in a more user-friendly and simple manner and thereby to extend the life of a cellulose-containing garment.

### SUMMARY OF THE DISCLOSURE

The present disclosure solves or at least mitigates the above-described problems in the art by providing a user-friendly cellulase-containing composition and a method for restoring of used garments, based on a high concentration of cellulase to restore the surface, visual and mechanical properties of deteriorated cellulose containing second hand/used garments, to be performed at home or in a professional, non-industrial, setting.

The present disclosure provides a composition and a method that give dependable, consistent and reproducible results while keeping in mind the variability of factors in a domestic washing environment. By using the presently disclosed formulation and process, the life of a cellulose-containing garment can be increased multiple times.

More particularly, presently disclosed is the use of a composition for restoring of a cellulose-containing used garment in a non-industrial laundry equipment selected from a domestic laundry equipment and a professional non-industrial equipment, wherein the composition comprises from about 15% to about 60% of a cellulase preparation, wherein the restoring is selected from a group consisting of: (i) restoring of a mechanical tension of the garment, thereby achieving a re-shaping of the garment, (ii) de-pilling of a surface of the garment, and (iii) de-fraying of a collar(s) and/or edge(s) of the garment, and any combinations thereof.

The present disclosure also provides a composition for use in restoration of a cellulose-containing used garment in a non-industrial laundry equipment selected from a domestic laundry equipment and a professional non-industrial equipment, said composition comprising:
a. from about 15% to about 60% of a cellulase preparation, such as, from about 15% to about 60% by weight, or from about 15% to about 60% by volume, of the cellulase preparation;
b. from about 30% to about 90% of a carrier, such as, from about 30% to 60% by weight, or from about 70% to about 90% by volume, of the carrier;
c. from about 0.5% to about 10% of a buffering and/or sequestering agent, such as, from about 3% to 9% by weight, or from about 0.5% to about 10% by volume, of the buffering and/or sequestering agent; and
d. optionally from about 10% to about 20% of a sequestering agent, such as from about 10% to about 20% by weight or from about 10% to about 20% by volume of a sequestering agent;
e. optionally from about 1% to about 8% of one or more surfactants, such as from about 1% to about 5% by weight of a first surfactant and/or from about 0.5% to about 1.5% by weight of a second surfactant, or from about 1% to about 5% by volume of a first surfactant and/or from about 0.5% to about 1.5% by volume of a second surfactant;
   provided that the percentages of (a)-(e) are either all by weight or all by volume.

Further, the present disclosure provides a method for restoring a cellulose-containing used garment, said method comprising:
a. Adding of a cellulose-containing used garment and a composition comprising from about 15% to about 60% of a cellulase preparation to a non-industrial laundry equipment selected from a domestic laundry equipment and a professional non-industrial equipment;
b. Washing of the garment in the presence of the composition, at a temperature of from about 20° C. to about 60° C., for a time period of from about 60 minutes to about 240 minutes, such as from about 120 minutes to about 180 minutes, at a drum rotation speed of a minimum of 300 rpm;
   wherein the restoring is selected from a group consisting of: (i) restoring of a mechanical tension of the garment, thereby achieving a re-shaping of the garment, (ii) de-pilling of a surface of the garment, and (iii) de-fraying of a collar(s) and/or edge(s) of the garment, and any combinations thereof, preferably wherein the composition comprising the cellulase preparation is the composition as presently disclosed in detail elsewhere herein.

### BRIEF DESCRIPTION OF THE DRAWINGS

FIG. 1 schematically depicts the difference between (A) fuzz, (B) pill, and (C) fray.

FIG. 2 is a photograph of a typical pill in knitted fabric (source: anon. 1972).

FIG. 3 shows photographs of grade 1 to grade 5 on a ASTM International's standard scale of pilling of textile surfaces based on visual assessment. FIG. 3(A) shows Grade 5: No pilling; FIG. 3(B) shows Grade 4: Slight pilling; FIG. 3(C) shows Grade 3: Moderate pilling; FIG. 3(D) shows Grade 2: Severe pilling; FIG. 3(E) shows Grade 1: Very severe pilling.

FIG. 4 shows photographs of grade 1 to grade 4 of fraying of an edge or part of a garment according to an internal standard of fraying based on visual assessment, as used by the present inventor. FIG. 4(A) shows Grade 4: No fraying; FIG. 4(B) shows Grade 3: Low fraying; FIG. 4(C) shows Grade 2: Medium fraying; FIG. 4(D) shows Grade 1: Severe fraying.

FIG. 5 schematically depicts a method as presently disclosed herein. The method comprises at least step a and step b, and may further comprise one or more additional steps, selected from step c, step d1, and/or step d2. An arrow drawn as a dashed line indicates that the subsequent step is optional.

FIG. 6 illustrates the effects of the presently disclosed composition, use, and/or method. FIGS. 6 (A), (A1), (A2), (A3), and (A4) relate to characteristics of a new garment. FIGS. 6 (B), (B1), (B2), (B3), and (B4) relate to characteristics of a used garment, not treated according to the present disclosure. FIGS. 6 (C), (C1), (C2), (C3), and (C4) relate to characteristics of a used garment after treatment with the presently disclosed composition, use, and/or method.

FIG. 7 shows two photographs of a sleeve of a used knitted garment, wherein the photograph in FIG. 7 (A) was taken before, and the photograph in FIG. 7 (B) was taken after, restorative treatment according to the present disclosure.

FIG. 8 shows two photographs of a close-up version of part of the sleeve shown in FIG. 7, wherein the photograph in FIG. 8 (A) was taken before, and the photograph in FIG. 8 (B) was taken after, restorative treatment according to the present disclosure.

FIG. 9 shows two photographs of a used printed t-shirt, wherein the photograph in FIG. 9 (A) was taken before, and the photograph in FIG. 9 (B) was taken after, restorative treatment according to the present disclosure.

### DETAILED DESCRIPTION OF THE DISCLOSURE

The presently disclosed composition and method were designed to solve the following objectives:
An easy-to-use composition comprising cellulase, for use in restoration of cellulose-containing used garments.
A composition which can remove any level of pilling, i.e., grade 1 to grade 4 based on ASTM International's standard scale of grades of pilling, as described in FIG. 3 and Table 1 herein.
A method for restoring of cellulose-containing used garments, which method can easily be performed using manual or automatic domestic laundry machines or professional, non-industrial, laundry machines.
Flexibility to treat different types of cellulose-containing garments together, with the same composition and/or with the same method.

The present disclosure is based on a composition in which several factors related to its activity and efficiency have been optimized to get the desired restorative impact. These factors include selection of a suitable cellulase preparation, its concentration in the composition, dosage per weight of garment, transportation, pH regulation, enzyme stability, maximizing accessibility of protruding fibre, mechanical agitation for fibre wear off etc. The presently disclosed method has been developed and fine-tuned to adapt it to performing in domestic and professional, non-industrial, laundry machines using their native features. Other factors taken into consideration were the flexibility to cater a wide range of substrate weights, constructions, sizes, and compositions. This makes it extremely easy for consumers to either restore attributes of a purchased second-hand garment or a garment that they currently use that has started to show signs of wear.

Furthermore, the components of the composition have been selected with the aim of providing a sustainable, environmentally friendly composition.

### Terms and Definitions

All words and terms used throughout the present text shall be considered to have the same meaning usually given to them by the person skilled in the art unless another meaning is apparent from the context.

Herein, the terms “restoration” and “restoring” of a used garment are intended to mean restoration/restoring of at least one characteristic of the used garment. The at least one characteristic may be selected from the following non-limiting list of characteristics: mechanical tension of the garment, which influences the shape of the garment, visual appearance of the surface of the garment, tactility of the surface of the garment, and structure of the garment. Accordingly, the acts of restoration/restoring which may be achieved by use of the presently disclosed composition include, but are not limited to, the following acts: restoring of the mechanical tension of the garment, thereby achieving a re-shaping of the garment, de-pilling of the surface of the garment, de-fraying of collars and edges of the garment, and any combinations thereof. Herein, the terms “restoration” and “restoring” are synonymous to “rejuvenation” and “rejuvenating”, respectively. Herein, the terms “restoration” and “restoring” are not intended to mean cleaning, cleansing, or removing of stains or dirt. The presently disclosed composition can be applied to a clean (as opposed to dirty) used garment. Alternatively, the presently disclosed composition may be applied in combination with a regular detergent to a dirty used garment, in which case the regular detergent effects a cleaning of the used garment, while the presently disclosed composition effects a restoration of the used garment as defined herein. As used herein, restoration/restoring of a used garment naturally excludes any kind of treatment of a new fabric or garment, such as industrial bio-polishing or industrial bio-finishing, which are terms described in more detail elsewhere herein. Further, it is to be understood that the restoration/restoring does not have to achieve a 100% restoration back to the original value or level of a characteristic of the garment when it was new. The restoration/restoring may be to a degree of about 50%-100% of the original value or original level of the applicable characteristic, such as at least about 50%, 60%, 70%, 80%, 90%, or 100%.

The term “cellulose-containing” in connection with garments, textile materials, or fabrics, as used in the present disclosure, refers to garments, textile materials, or fabrics composed solely or partly of cellulosic fibres. The garments, textile materials, or fabrics include fibre, yarn, woven fabric, knit, or a ready-made garment, in whose manufacture cotton, flax, linen, hemp, ramie, jute or man-made cellulosic fibres, for example, viscose, Modal, lyocell (e.g. Tencel), cupro, etc., have been used as raw material. When using synthetic man-made fibres, the amount of cellulosic fibre in the textile material must be at least 30 percent for the herein disclosed cellulase-containing composition to have its intended effects on the materials or fabrics.

Herein, unless otherwise specified, the term “cellulase” refers to a group of three different enzymes, which together degrade cellulose. The three enzymes are endo-glucanase, EC 3.2.1.4, cello-biohydrolase, EC 3.2.1.91, and b-glucosidase (i.e., beta-glucosidase or B-glucosidase), EC 3.2.1.21. The group of these three different enzymes are commonly referred to by use of the term “cellulase”.

The term “cellulase preparation” as used herein is intended to mean a cellulase in granulated form or, in other words, a granulated cellulase. More particularly, a cellulase preparation as referred to herein is a preparation comprising cellulase and any additional component(s) capable of forming a granulate which carries the enzyme. Even more particularly, a cellulase preparation as referred to herein means a preparation comprising the three enzymes commonly referred to as cellulase (as defined above), i.e., endo-glucanase, cello-biohydrolase, and b-glucosidase, and further comprising one or more granulating agents, and optionally comprising additional excipients. A cellulase preparation as referred to herein may alternatively be called a cellulase concentrate or a granulated cellulase concentrate.

A “granulating agent” is intended to mean any ingredient or component required to form a granulate.

Enzyme activity is expressed herein by use of different units for the enzyme activity, depending on the types of cellulase preparations referred to. The standardized enzyme activity unit is expressed as units (U) per gram of substrate. The definition of the standardized enzyme unit U is the amount of enzyme that converts one micro mole of substrate per minute. One unit (U) will liberate 1.0 μmole of glucose from cellulose in one hour at pH 5.0 and 37° C. However, in the enzyme industry, it is common practice among manufacturers to establish and refer to other enzyme activity units than the standardized unit. The names of such other units may be constructed by adding different prefixes and suffixes to the standardized unit U to give an indication of the types of enzyme referred to. For example, as used herein in relation to the cellulase preparations and compositions described herein, ECU means endocellulase units and is used for a cellulase preparation containing a high amount of endoglucanase, CCU means combi cellulase units, and CNU-LTC means neutral low temperature cellulase units. Further, enzyme manufacturers may not always use the conditions according to the definition of the standardized enzyme unit U when measuring the enzyme activity of any given enzyme preparation. Instead, slightly different measurement conditions may be used by manufacturers for different enzyme activity units and such conditions may not be publicly available. Consequently, the measurement conditions used by the manufacturer for establishing the enzyme activity of the herein described cellulase preparations, expressed as CCU/g, CNU-LTC/g, ECU/g etc., may, or may not, be pH 5.0 and 37° C.

Herein, a composition which is a powder (i.e., which is in the form of a powder) may be called a “powder composition”. The powder may be granulated, in which case the powder may alternatively be called a granulate.

A composition which is a liquid (i.e., which is in the form of a liquid) may be called a “liquid composition” herein. The presently disclosed liquid composition may be a solution, i.e., a homogenous mixture of two or more components, or it may be a dispersion or suspension, comprising two liquids which do not mix, e.g., one liquid is dispersed or suspended in the form of fine droplets in a continuous phase of another liquid.

The term “% by weight” of a component comprised by a composition as referred to herein means % by weight of the component in relation to the total weight of the composition. The “weight” may be either dry weight, or wet weight. The term “dry weight” is intended to mean the weight of a composition wherein most of the water has been removed therefrom, such as by a drying process.

Similarly, the term “% by volume” of a component comprised by a composition means % by volume of the component in relation to the total volume of the composition.

Herein, the term “on weight of fabric” may be used interchangeably with “on the weight of fabric”, “of the weight of fabric”, “of the weight of garment” and similar terms. The abbreviation for “on weight of fabric” is “OWF”. In the textile industry, the dosage of a compound for treatment of fabrics is often expressed as percentage of the compound on weight of fabric, meaning percentage of the compound in relation to the total weight of the fabric to be treated.

Notably, all percentage amounts (irrespective of whether by weight or by volume) as mentioned herein may generally at least vary about 1-5% of the percentage mentioned, i.e., ±1-5% of the specified percentage. As a non-limiting example, the value of 30% by weight or by volume of a cellulase preparation may vary by at least ±1% of the 30% (i.e., ±0.01×30%=±0.3%), resulting in values of from 29.7% to 30.3% by weight or by volume of the cellulase preparation, and it may vary as much as ±5% of the 30% (i.e., ±0.05×30%=±1.5%), resulting in values of from 28.5% to 31.5% by weight or by volume of the cellulase preparation.

Accordingly, the term “about”, when used together with a specified percentage amount by weight or by volume, may be replaced by “±1-5%” of the percentage amount as specified.

The term “carrier” is intended to mean a component, which helps in building up the bulk of a composition (whether in powder form or liquid form), in the movement and transport of a cellulase to the substrate. Herein, the term “carrier” may be used interchangeably with terms like “filler”, “builder”, and “bulking agent”.

The term “buffering agent” is herein intended to refer to a compound used to control and adjust the pH of a liquid in which the buffering agent is present.

The term “sequestering agent”, also known as a chelating agent, is intended to mean a compound used to remove water hardness. A sequestering agent surrounds another molecule or atom and prevents it from taking part in chemical reactions. In aqueous solutions, these compounds combine with metal ions, like calcium, to substantially inactivate the ion. Calcium, and other hard water ions, readily combine for example with surfactants in detergents and reduce their cleaning effectiveness. By inactivating the ion with a sequestering agent, detergents are better able to clean clothes.

The term “surfactant” means a compound which tends to reduce the surface tension of a liquid in which it is dissolved.

Herein, the compositions may also comprise one or more “excipients”, which term is mainly used to describe other ingredients present in the composition, such as ingredients added thereto in order to, in other manners than buffering agents and/or sequestering agents, preserve stability or prevent degradation of the composition. Another purpose of an excipient can be to achieve desired powder properties. For example, a granulating agent may be added to achieve granulation, e.g., to make a powder less dusty. Another non-limiting example is an excipient which gives free-flowing properties to a powder, to make a powder less cohesive (sticky). Yet another purpose of an excipient can be to prevent microbial growth.

The term “preservative agent” means an agent or excipient that prevents microbial growth.

Herein, the terms “industrial bio-finishing” and “industrial bio-polishing” refer to the use of enzymes on new textiles, new fabrics, or new garments, in a controlled hydrolysis of cellulosic fibres in order to modify the newly produced fabric or yarn surface in a manner that prevents permanent pilling, improves fabric handle (i.e., how the fabric feels upon touch, like softness and smoothness), clears the surface structure by reducing fuzzing, which results in clarification of colours, improves the drapability of the fabric, improves moisture absorbability and which may improve also the dyeability. Bio-polishing is a type of bio-finishing. In other words, the term “bio-finishing” is broader than the term “bio-polishing”. However, in the present context the two terms may be used interchangeably. When using the term “bio-finishing” herein, the bio-polishing aspect of bio-finishing is intended unless otherwise stated.

By “detergent” is meant a cleansing agent that can contain surface active agents (anionic, non-ionic, cationic and ampholytic surfactants), builders and other optional ingredients such as anti-redeposition and soil suspension agents, optical brighteners, bleaching agents, dyes and pigments and hydrolases.

“Pilling” vs “fuzz”: “Fuzz” is the designation for short fibres or immature fibre neps protruding from the surface of the yarn and fabrics. This fuzz formation results in pilling of the clothes, making them unattractive. Fuzz is untangled fibre ends that protrude from the surface of a yarn or fabric. “Pill” or “pilling” is bunches or balls of tangled fibres which are held to the surface of a fabric by one or more fibres (Annis, 2005).

“Pill formation”: Generally, pills are formed in areas that are especially abraded or rubbed during wear and can be accentuated by laundering and dry-cleaning. The rubbing action causes loose fibres to develop into small spherical bundles anchored to the fabric by few unbroken fibres.

“Anti-pilling” is a process performed on a new fabric during its production so as to reduce its potential to create pills later on. At the time of applying an anti-pilling process to a fabric, the fabric does not yet have pills on it. The fabric merely has loose and hairy fibers that could lead to pilling at a subsequent use stage. Anti-pilling may be part of a bio-polishing procedure, which is an enzymatic treatment. However, anti-pilling may alternatively be carried out using other techniques than bio-polishing, for example by applying a polymeric coating on the fabric, which is a non-enzymatic, chemical treatment. Anti-pilling is a preventive measure applied to new fabrics.

“De-pilling” is a process of removing pills once they have occurred on a garment during the use phase. De-pilling of a used garment may be done mechanically by a consumer, e.g., by manually applying a de-pilling apparatus to the garment or removing pills by hand, which is a tedious and time-consuming task, and yet does not result in a surface completely free from pills and fuzz. Alternatively, as presently disclosed, de-pilling may be achieved much more efficiently by an enzymatic treatment. In contrast to anti-pilling, de-pilling is not a preventive measure; it is taking care of a problem that has already occurred.

A “used” garment herein refers to a garment, which after purchase has gone through at least one laundry cycle/process, at home or at a professional, non-industrial laundry setting. Thus, a used garment may not necessarily have been worn yet, although that will most commonly be the case before there is a need to apply the presently disclosed composition, use or method to the garment. A used garment may, or may not, be worn-out and/or second-hand.

A “new” garment herein refers to a garment, which has been purchased (normally by a consumer, e.g., from a store or from another consumer) and which has not yet gone through any laundry cycle/process, neither at home nor at a professional laundry service.

The term “serviceable” should encompass all those criteria of performance which permit a product to be accepted or rejected. Such criteria include (unwelcome changes in) appearance, comfort, handling, strength, and wear.

Herein, “de-shaping of a garment” is intended to mean when a garment becomes loose, or loses its symmetry etc. Further, the term “re-shaping of a garment” means restoring the original shape of the garment or at least restore the shape of the garment to a certain extent.

The “dimensional stability” is an attribute of a fabric or garment to retain its shape.

“Wear” is the process of decomposition accelerated by chemical and physical environment or by use, time and exposure. Wear should be regarded as a more confining word which describes the ability of a material to withstand a variety of mechanical actions in different chemical and physical environments (Elder, 1978).

The term “stress environment” is intended to mean the physical and chemical conditions that a textile or garment is exposed to, including but not limited to abrasive forces, abrasion surfaces, tensile force from body shaping and movements, ironing, detergency, bleaching, temperature, moisture.

The term “laundry equipment” is synonymous to the term “washing equipment”. A laundry equipment includes a laundry machine.

The terms “washing machine”, “wash machine”, “laundry machine”, and “laundering machine” may be used interchangeably herein. “Washing” of clothes or garments is intended to be synonymous to “laundering” of clothes or garments.

The term “non-industrial laundry equipment” includes domestic laundry equipment as well as professional, non-industrial laundry equipment, such as dry cleaners' laundry equipment.

The term “domestic laundry environment”, in contrast to lab environment, means that there is no control on ambient environment such as temperature, humidity, lighting etc.

A “professional, non-industrial laundry industry” includes consumer-facing laundry and dry-cleaning service that sell their services directly to consumers.

The term “industrial manufacturing” refers to factories that process textile material to be used in products that are sold as “new” to the consumers. This covers both virgin and recycled fibres. It also refers to the industrial segment who as an entity does not sell directly to end-consumers.

Herein, “industrial raw material” refers to fibres, yarn and textiles from new or recycled sources, which are processed in factories to be used in the next industrial process.

The term “drum rotation at a minimum of x rpm” is meant to indicate the minimum value of drum rotations per minute when there is consistent drum rotation, as opposed to when the machine is pausing, accelerating or decelerating. Herein, the term “drum rotation” may be used interchangeably with the terms “spinning”, “centrifugation”, and “centrifuging”.

Herein, compositions “comprising” one or more recited elements may also include other elements not specifically recited.

Herein, the singular “a” and “an” shall be construed as also including the plural.

Types of Fibre Protrusions

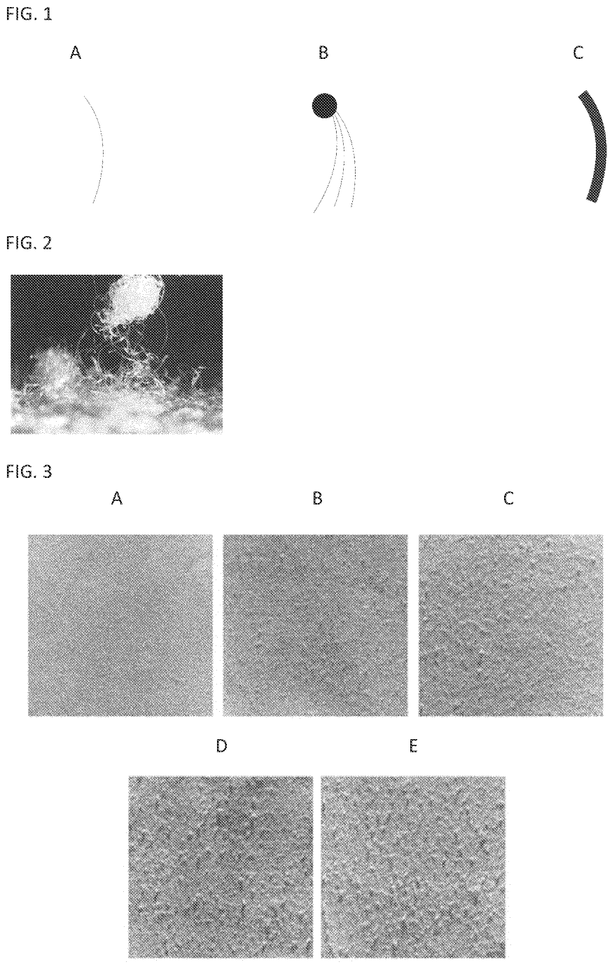

There are several types of fibre protrusions, which may appear in fabrics or garments, all having their own characteristics. FIG. 1 schematically illustrates (A) fuzz, (B) pill, and (C) fray, and how they differ from each other. Fuzz is the hairiness on the surface of a garment and comprises loose individual fibres. Fuzz is a precursor to pill formation, also called pilling, which has long been recognized as one of the biggest problems in textiles that are in consumer use. All garments have a pilling propensity which is determined by the rates of fuzz formation, entanglement, and pill wear off. A pill is formed quickly when fuzz density reaches a critical level as the fibre starts to entangle. FIG. 2 illustrates the mechanism of pill formation in detail. FIG. 3 shows ASTM International's standard scale of pilling of textile surfaces based on visual assessment. FIG. 3(A) shows Grade 5: No pilling; FIG. 3(B) shows Grade 4: Slight pilling; FIG. 3(C) shows Grade 3: Moderate pilling; FIG. 3(D) shows Grade 2: Severe pilling; FIG. 3(E) shows Grade 1: Very severe pilling. FIG. 3 is based on ASTM International's Adjunct to D3512 Test Method for Pilling Resistance and Other Related Surface Changes of Textile Fabrics: Random Tumble Pilling Tester. Said adjunct can also be used as a reference with other standard test methods. Said adjunct consists of five photographs, which illustrate varying degrees of pilling and related surface changes which could be encountered on a typical fabric. They vary from No. 1—Very Severe Pilling, to No. 5—No Pilling. Tested specimens may be compared with the photographs of said adjunct. In Table 1, a brief written description of the meaning of all grades is provided.

TABLE 1
ASTM International's standard scale of grades of pilling
on textile surfaces based on visual assessment

| Grade | Description |
|---|---|
| 5 | No pilling |
| 4 | Slight surface fuzzing and/or partially formed pills |
| 3 | Moderate surface fuzzing and/or moderate pilling. |
| | Pills of varying size and density |
| | partially covering the specimen surface. |
| 2 | Distinct surface fuzzing and/or distinct pilling. |
| | Pills of varying size and density covering a |
| | large proportion of the specimen surface. |
| 1 | Dense surface fuzzing and/or severe pilling. Pills of varying |
| | size and density covering the whole of the specimen surface. |

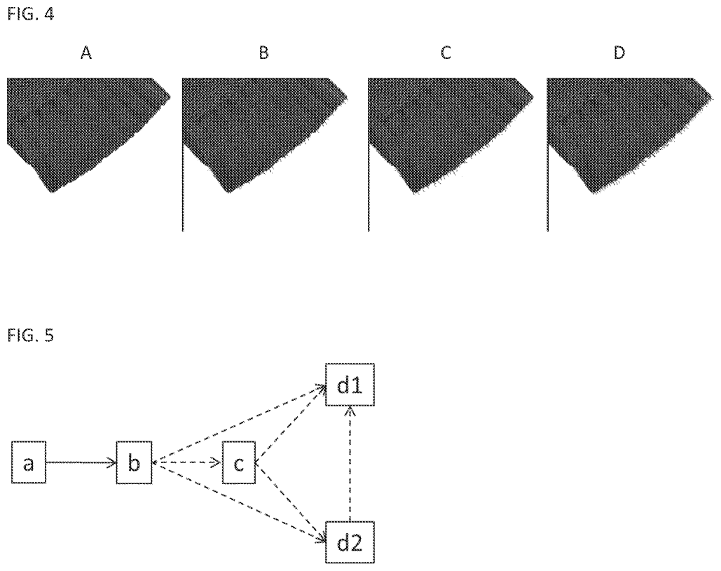

Frays are the loose threads that pop out of a garment's edges or parts, which are thicker and go through more abrasion or rubbing than the rest of the garment. Such edges or parts include collars, cuffs, hems, plackets, etc. FIG. 4 shows an internal standard of fraying based on visual assessment, as used by the present inventor. FIG. 4(A) shows Grade 4: No fraying; FIG. 4(B) shows Grade 3: Low fraying; FIG. 4(C) shows Grade 2: Medium fraying; FIG. 4(D) shows Grade 1: Severe fraying.

Causes of Fuzz, Pilling, Fibrillation and Fraying on a Garment During Consumer Use

There are several factors that cause the different types of fibre protrusions during the use phase, including end-use, wear conditions, washing and dry-cleaning conditions, fibre properties, yarn properties, fabric properties, fabric finishing, and relative humidity. There are also additional factors to take into consideration such as rate of pilling, density of pill, pill size, pill number and colour. Pilling, fuzzing, and fraying appear through mechanical action on the fabric. Abrasion or rubbing causes loose fuzz to develop into small spherical bundles anchored to the fabric by few unbroken fibres. This pilling and fuzzing effect can be heightened by laundering and dry-cleaning, depending upon the type and composition of the detergent used (Fan and Hunter, 2009).

Impacts of Fuzz, Pilling, Fibrillation and Fraying on a Garment During Consumer Use

The different types of fibre protrusions have a domino effect on other attributes of garment deterioration such as dimensional changes, colour fading and wearing of parts.

Dimensional changes like bagging is a stretch phenomenon commonly observed in knitted garments and occurs at cuffs, ankles, and collars (Mehta, 1992). This is initially caused due to the use of fabric having poor elastic properties. Other dimensional changes include shrinkage and stretching of high magnitude such that the garment no longer fits. These dimensional changes are a consequence of fibre disorientation and disruptive fibre fibrillation due to repeated domestic laundering and drying, during which the fabric is exposed to chemical action of detergents and abrasion due to friction and tensile force.

The appearance of a colour fading to a human eye means that the colour does not look dark, brilliant, and clear. Some coloured or printed garments change colour significantly during use. This may be caused by abrasion, rubbing, atmospheric conditions such as ultraviolet (UV) light, oxides of nitrogen or ozone, acidic or alkaline substances, laundering or dry-cleaning, ironing, perspiration, rainwater, chlorinated water, or sea water. The colour fading perception is not just a result of the dye leaving the fibres. The faded appearance results due to fuzz and pilling on the surface which make the surface irregular, and which results in irregular diffraction of light waves upon impact with the surface. Pill density differs with fabric density, and the pilling prevents the light to pass through substrate and leads to shadow formation. Pilling can cause changes in the surface such as loss of cover factor, colour change and fuzzy extension (Marjan Barakzehi et al, 2016).

Colour loss due to abrasion may be caused by localized wear such as rubbing the elbows against a desk, excessive mechanical agitation during washing or an attempt to remove a stain by rubbing.

Wearing of collars, cuff edges, and other folded edges may result in a frayed appearance. Many of these changes are caused or accelerated by the disorientation and disruptive fibre fibrillation that occur due to the chemical action combined with abrasion due to friction and tensile force. This happens to all garments regardless of the quality of the new garment, the difference is that of speed. In lower quality garments that use shorter fibre staple lengths the deterioration takes place faster than in garments that use higher staple length fibres. The wearing too is an outcome of fibrillation and its types.

The different negative impacts of fibrillation and its different types are clearly visible on the surface of a worn-out garment, which may make a consumer decide to throw away the garment although it is still functional. This was the initial problem that made the present inventor motivated to develop a home-based solution for consumers, such that the various negative impacts may be decreased, and the life of garments may be extended. The solution as presently disclosed enables removal of all types of fibrillations. Hence, the herein disclosed composition and use of the composition, and the herein disclosed kit of parts and method for restoring a cellulose-containing used garment, is each characterised by being capable of (i) restoring of a mechanical tension of a garment, thereby achieving a re-shaping of the garment, (ii) de-pilling of a surface of a garment, and (iii) de-fraying of a collar(s) and/or edge(s) of a garment. In this context, the classification and understanding of the different types of fibrillations is important since the varying size dimensions, weights, and varying strength of attachment with the surface of the different types of fibrillations have a direct impact on the presently disclosed composition and process design, as explained in more detail elsewhere herein.

Cellulase Action and the Enzyme Hydrolysis Process

The group of enzymes that hydrolyse the b-(1,4)-linkages in cellulose consists of three different types of enzymes that act synergistically in the hydrolysis of cellulose. Endo-glucanase, EC 3.2.1.4, randomly hydrolyzes the b-(1,4)-linkages within the water-insoluble cellulose chain. Cello-biohydrolase, EC 3.2.1.91, hydrolyzes the linkages at the reducing ends of cellulose chains to form cellobiose. Finally, b-glucosidase (i.e., beta-glucosidase or B-glucosidase), EC 3.2.1.21, converts the water-soluble cellobiose into two glucose residues. The group of these three different enzymes are commonly referred to by use of the term “cellulase”. Cellulase is a large molecule, making it difficult to enter the interior crystalline region of the cellulose fibre. Thus initially, it acts on the surface and breaks the cellulose chains randomly. Then it specifically attacks the open structure. During this enzymatic process, loose fibres break off. Any mechanical action accelerates the fibre breakage process.

Enzymatic hydrolysis of cellulosic biomass depends on many factors: physical properties of the substrate (composition, crystallinity, degree of polymerization, etc.), enzyme synergy (origin, composition, etc. of the three different enzymes of the group of enzymes jointly called cellulase), mass transfer (substrate adsorption, bulk, and pore diffusion, etc.), and intrinsic kinetics. The accessibility of the fibre surface to the enzyme is a rate-determining factor in the enzymatic hydrolysis (Mansfield et al. 1999). Cellulase action on cellulose is a keylock mechanism. The cellulase's actions on cellulose primarily depend on cellulase activation through temperature and pH, followed by a keylock mechanism. In any environment which is conducive for cellulase activity, e.g. in terms of temperature and pH, the cellulase will start its breaking action on cellulose.

In a used garment, which has a fibrillated surface, each individual protruding fibre is accessible for hydrolysis.

For basic hydrolysis, the concentration, dosage per weight of substrate, and mechanical agitation are not important. These factors only come into play when the method and composition are engineered to obtain the objects of the present disclosure, as described in detail elsewhere herein.

Cellulases are commercially available, both in powder form and in liquid form. Different types of cellulase may be used according to the present disclosure, as described in more detail elsewhere herein.

Differences Between Industrial Bio-Finishing of New Garments and Restoration of Used Garments

Compared to previously known enzyme compositions, uses, and methods applied in industrial bio-finishing of textiles, such as in industrial bio-polishing of textiles (see e.g. Novozymes, https://www.novozymes.com/en/advance-your-business/textiles/biopolishing/), the presently disclosed compositions, uses, and methods for restoration of used garments differ in terms of end goal, components of the composition, processing conditions and equipment, condition or state of substrate, as further described in Table 2 and elsewhere herein.

Industrial bio-finishing has been used to remove all kinds of impurities and individual loose fibre ends that protrude from the textile surface. Like other pre-treatment processes like sizing, wetting etc. this is not a permanent or regular process, but rather an optional treatment used as and when needed and depending on the final product goal and budget.

The main objectives of the industrial bio-polishing is to upgrade the quality of the fabric by removing the protruding fibres, which in this context may be referred to as “fuzz”, from the surface, and to modify the surface structure of the fibre, thereby making it soft and smooth to increase the depth of colour during dyeing (Vigneswaran et al, 2011). Today, different types of bio-polishing enzymes are used for industrial textile pre-treatment processes. The selection of bio-polishing enzyme in the pre-treatment depends upon the type of fibres used, class of dyes that would need to be used and other auxiliaries in the portfolio of the manufacturer which then need to be compatible with the operating conditions of the bio-polishing enzyme. Among the different product categories, industrial bio-finishing is mostly used on knits as they have higher propensity to fuzz even as a new fabric in contrast to woven fabrics which are much smoother and less fuzzy during the production stage.

Industrial bio-polishing is targeted towards prevention of pilling, i.e., anti-pilling, or in other words, as a means of reducing pilling tendency in a new fabric. This is not the same as de-pilling of a used garment which already has developed pills, as described in more detail elsewhere herein.

The fundamental characteristics of a new material includes its form, handling, exposure to ambient environment, processing, subjected stress etc. which are all controlled parameters, whereas a used garment when worn and in use by a consumer is exposed to a wide variety of uncontrollable physical and chemical stresses.

TABLE 2
Differences between industrial bio-finishing of new garments and the present disclosure

| | Industrial bio-finishing | Present disclosure |
|---|---|---|
| Goal | Reduce fuzz for to get colour depth in | Remove pilling and fraying, recover |
| | dyeing. Mostly done on un-coloured | mechanical tension and dimensional |
| | garments. | stability (shape), recover cuffs and collars. |
| Batch | One type of fabric per batch, i.e., a | Mixed batch of different garments having |
| | single specification, single weight, | different specifications, different GSM, |
| | consistent construction, consistent | different constructions, different |
| | composition, consistent raw material | compositions, different raw material |
| | source | source |
| Equipment | Continuous dyeing machines | Standard domestic washing |
| | Jiggers and/or winches, for | machine (automatic/manual) |
| | dyeing and wet processing | having prewash, rinse, centrifuging |
| | Industrial laundry machines | capacity; limited settings for |
| | All equipment having fully | temperature and rpm |
| | customizable parameters | Tumble dryer either separate or |
| | | built into the domestic laundry |
| | | machine, limited settings for |
| | | temperature and rpm |
| | | Professional, non-industrial |
| | | washing machine, having higher |
| | | capacity (i.e., accommodates a |
| | | larger volume/weight of garments) |
| | | than a domestic washing machine. |
| Pre-processing | Usually sizing or pre-wetting of the | No pre-processing |
| | fabrics | |
| Post-processing | Dyeing | No post-processing |

Differences Between Detergents Used in Laundering Processes and Restoration of Used Garments

Compared to previously known detergent compositions, uses, and processes applied in the laundering of clothes, the presently disclosed compositions, uses, and methods for restoration of used garments differ in terms of effects, end goal, components of the composition, and processing conditions, as further described in Table 3 and elsewhere herein. The primary purpose of using enzymes in detergency is to catalyze breakdown of protein- or carbohydrate-based stains to facilitate the removal by surfactant and builder, i.e., the cellulase use in detergents is designed for optimizing the cleaning impact. If present in detergents, enzymes are a minor component of the composition, and would not provide the remarkable restorative actions, which have been achieved by use of the presently disclosed compositions and methods. The components of detergents and the actions of regular laundering processes may even contribute to the undesirable loss of attributes of newness of garments and lead to the occurrence of pilling and fraying of garments.

TABLE 3
Differences between detergents and the present disclosure

| Detergents | Present disclosure |
|---|---|
| Goal: Oil removal, soil removal | Goal: Remove pilling and fraying, recover |
| (blood, ink, milk etc.) | mechanical tension and dimensional stability |
| | (shape), recover cuffs and collars. |
| Micro-foaming agents are included in detergent | Mechanical action is desired to obtain a quick |
| compositions to reduce the mechanical action | result and high efficiency |
| during the wash cycle with the big advantage of | |
| increased textile care | |
| Enzymes are very susceptible to degradation | No proteolytic substances |
| and deactivation by aggressive proteolytic | |
| substances such as most anionic surfactants | |
| used in detergents, e.g., sodium lauryl sulfate | |
| and linear alkyl benzene sulfate | |
| Protease is the most common enzyme used in | No protease |
| detergents to dissolve protein-based soil, which | |
| is also detrimental to cellulase as it is a protein | |
| Enzymes are generally present as minor | Cellulase preparation is a major component of |
| components in detergents; normally about | the composition, at least 15% by |
| 0.01%-1% by weight | weight/volume |

Below follows a more detailed description of the different aspects and embodiments of the present disclosure.

The present disclosure provides use of a composition for restoring of a cellulose-containing used garment in a non-industrial laundry equipment selected from a domestic laundry equipment and a professional non-industrial equipment, wherein the composition comprises from about 15% to about 60% of a cellulase preparation, wherein the restoring is selected from a group consisting of: (i) restoring of a mechanical tension of the garment, thereby achieving a re-shaping of the garment, (ii) de-pilling of a surface of the garment, and (iii) de-fraying of a collar(s) and/or edge(s) of the garment, and any combinations thereof.

In the above-disclosed use, the cellulase preparation, as described in detail further below, may be used at a dosage of at least about 3.5% of the weight of said cellulose-containing used garment. Such a dosage may contribute to the composition's capability of de-pilling of the surface of the garment from very severe pilling to no pilling based on visual assessment.

In the above-disclosed use, the cellulase preparation, as described in detail further below, may have a cellulase activity of at least about 171 Endocellulase units per gram (ECU/g) of substrate. Such an enzyme activity may contribute to the composition's capability of de-pilling of the surface of the garment from very severe pilling to no pilling based on visual assessment.

The composition referred to in the above-disclosed use may comprise from about 15% to about 60% by weight or by volume of the cellulase preparation, such as from about 20% to about 55%, from about 25% to about 50%, from about 30% to about 45%, or from about 35% to about 40%, by weight or by volume, such as about 15%, 20%, 25%, 30%, 35%, 40%, 45%, 50%, 55%, or 60% by weight or by volume of the cellulase preparation.

Table 4 gives non-limiting examples of suitable dosages of the presently disclosed composition, corresponding to different concentrations of the cellulase preparation in the composition. The dosage is expressed in terms of the weight of the composition, as well as in terms of percentage of composition on weight of fabric (OWF), the latter meaning percentage of composition in relation to the weight of garment to be restored. The non-limiting examples of dosages given in Table 4 are particularly suitable for a powder composition as disclosed in Example 1 herein.

TABLE 4
Dosage of presently disclosed composition
per 100 g of garment to be restored.

| Concentration of | Weight of | |
|---|---|---|
| cellulase preparation | composition | % of composition |
| in the composition | comprising cellulase | on weight of |
| (% by weight/volume) | preparation (g) | fabric (OWF) |
| 15 | 13.89 | 13.89% |
| 20 | 13.23 | 13.23% |
| 25 | 12.60 | 12.60% |
| 30 | 12.00 | 12.00% |
| 35 | 11.43 | 11.43% |
| 40 | 10.88 | 10.88% |
| 45 | 10.37 | 10.37% |
| 50 | 9.87 | 9.87% |
| 55 | 9.40 | 9.40% |
| 60 | 8.95 | 8.95% |
| Garment weight | 100 g | |

As may be derived from Table 4, the difference in dosage between the different concentrations of cellulase preparation corresponds to applying a dosage increase/decrease factor of approximately 1.05. The factor to be applied is approximate since the cellulase concentration in the composition is not directly proportional to the dosage and impact. The dosage scheme has been established based on a set of experiments. In this process, available surface area or fibre sites to be hydrolyzed were considered. Based on the approximate dosage scheme disclosed herein, a person skilled in the art understands that if the results obtained in experiments do not constitute sufficient restoration and/or are not sufficiently consistent, the dosage may need to be adjusted. Together, the dosage and the percentage of cellulase preparation ensure that sufficient amounts of cellulase get access to the fibre sites.

The dosage and/or the percentage of cellulase preparation in the composition may be adjusted depending on the enzyme activity of the cellulase preparation included in the composition. Different cellulase preparations have different enzyme activity levels. More particularly, the enzyme activity of relevance for the purposes of the present disclosure is the cellulase activity, meaning the cellulose-degrading activity, of a cellulase preparation.

The enzyme activity, more particularly the cellulase activity, of cellulase preparations suitable to include in the presently disclosed composition may be about 171 ECU/g.

As non-limiting examples, the desired, restorative effects of the composition may be obtained with 15% of a cellulase preparation having high cellulase activity while 60% of a cellulase preparation having low cellulase activity may be needed to obtain the desired effects. Herein, a non-limiting example of a “high cellulase activity” is about 25% higher than the above-mentioned 171 ECU/g, and a non-limiting example of a “low cellulase activity” is about 25% lower than the above-mentioned 171 ECU/g.

As non-limiting examples, the desired, restorative effects of the composition may be obtained with a dosage of about 6 g of composition per 100 g of garment to be restored when the composition comprises a cellulase preparation having high cellulase activity. For a composition comprising a cellulase preparation having low cellulase activity, a suitable dosage may be about 30 g of composition per 100 g of garment to be restored.

An important aspect of the present disclosure is to make it very simple for consumers to obtain a remarkable restoration of their used garments, irrespective of the types of fibre in the garments and the types of washing machines available, and irrespective of any uncontrollable variations of conditions (e.g., temperature, time periods, drum rotation speed) of wash programmes of non-industrial laundry equipment. Accordingly, the dosages mentioned herein are suitable to obtain a remarkable restoration of used garments, irrespective of differences in types of fibres, deciding the percentage of cellulose in the garments, and other variable conditions as mentioned above. Any surplus of composition will simply be washed away at the end of the wash programme, as described in more detail elsewhere herein. The amount of cellulose present in a garment correlates to the number of binding sites available for the hydrolytic activities of cellulase. Consequently, a quantity of cellulase which is higher than the quantity needed to saturate all available binding sites does not increase the performance. For the same reasons, any surplus of cellulase will not be able to cause excessive hydrolysis of cellulose and thus will not damage a garment to be restored, e.g., by creating holes in the garment. However, it is to be understood that excess amounts of cellulase in combination with excess contact time, may eventually cause damage to a garment, excess contact time meaning that the active cellulase is allowed to stay in contact with a cellulose-containing garment for extended periods of time, such as at least twice as long as the suitable maximum time period of treatment as described in detail elsewhere herein.

The cellulase preparation comprised by the presently disclosed composition comprises endo-glucanase, i.e. EC 3.2.1.4, cello-biohydrolase, i.e. EC 3.2.1.91, and b-glucosidase (i.e. beta-glucosidase or B-glucosidase), i.e. EC 3.2.1.21. The proportions of the three different enzymes in the cellulase preparation may vary. It is presently believed that cellulase preparations which are enriched in endo-glucanase, meaning that they comprise a higher proportion of endo-glucanase than of cellobiohydrolase and b-glucosidase, may be particularly suitable for the restoration of cellulose-containing used garments in accordance with the present disclosure. Non-limiting examples of particularly suitable cellulase preparations may comprise at least ten times higher enzyme activity of endo-glucanase than the enzyme activity of either cellobiohydrolase or b-glucosidase or both, such as 10, 50, 100, or 1000 times, higher enzyme activity of endo-glucanase than the enzyme activity of either cellobiohydrolase or b-glucosidase or both.

Cellulase preparations suitable for use according to the present disclosure comprise cellulase in granulated form or, in other words, a granulated cellulase. More particularly, a cellulase preparation as referred to herein is a preparation comprising cellulase and any additional component(s) capable of forming a granulate which carries the enzyme. The granulated form eliminates the dusty behaviour of the enzyme and stops it from being airborne. More particularly, a cellulase preparation as referred to herein is a preparation comprising the three enzymes commonly referred to as cellulase (as defined elsewhere herein), i.e., endo-glucanase, cello-biohydrolase, and b-glucosidase, and further comprising one or more granulating agents, and optionally comprising additional excipients.

Non-limiting examples of granulating agents and other types of excipients suitable to use to achieve a cellulase preparation as referred to herein are described for example in the published patent application U.S. Pat. No. 4,876,198. Granulation per se is a well-known process and the detailed practice thereof as such forms no part of the present disclosure.

The presently disclosed composition may comprise a cellulase preparation (i.e., cellulase in granulated form) comprising neutral cellulases, having an optimum activity around pH 6-8, such as around pH 7. Alternatively, the composition may comprise a preparation comprising acid cellulases, having a pH optimum around pH 3-5.5, such as around pH 4-5. Preparations of neutral cellulases as well as preparations of acidic cellulases, which are ready-to-use and suitable to include in the presently disclosed composition, are commercially available. The CAS number for cellulase is 9012-54-8. Non-limiting examples of commercially available cellulases which are suitable for the purposes of the present disclosure are Cellusoft combi, Cellusoft L, Cellusoft CR, Carezyme 5000 T, and Carezyme 4500 L (Novozymes AS, Denmark), as well as Mazyme and Mazyme Liq (Aquitex, Portugal).

A presently preferred cellulase preparation is Mazyme (Aquitex, Portugal), which comprises neutral cellulases. These enzymes are active already at 20° C. and up to at least 60° C. but their optimum activity is at about 40° C. Further, these enzymes work at a pH of 5.5-8.0. The enzyme activity of Mazyme is 8200 Combi Cellulase Units per gram (CCU/g). The non-limiting examples of dosages given above in Table 4 are particularly suitable for a powder composition comprising Mazyme.

Another presently preferred cellulase preparation is Mazyme Liq (Aquitex, Portugal), which comprises neutral cellulases. These enzymes are active already at 20° C. and up to at least 60° C. but their optimum activity is at about 40° C. Further, these enzymes work at a pH of 4.5-7.5. The enzyme activity of Mazyme Liq is 19500 Neutral Low Temperature Cellulase Units per gram (CNU-LTC/g).

The presently disclosed composition, when used as disclosed in detail above (i.e., when used for restoring of a cellulose-containing used garment in a non-industrial laundry equipment selected from a domestic laundry equipment and a professional non-industrial equipment), may further comprise one or more carriers, one or more buffering and/or sequestering agents, and/or one or more surfactants, as described in detail further below. Suitable amounts of such additional components of the composition are also disclosed further below.

The composition disclosed herein does not comprise any enzyme inhibitor, or more specifically, does not comprise any cellulase inhibitor.

The restorative action provided by the use of a composition as disclosed herein, is selected from a group consisting of: (i) restoring of a mechanical tension of the garment, thereby achieving a re-shaping of the garment, (ii) de-pilling of a surface of the garment, and (iii) de-fraying of a collar(s) and/or edge(s) of the garment, and any combinations thereof. As shown in the experimental section, the use of a composition as disclosed herein is capable of achieving all of the above restorative actions (i), (ii), and (iii). Accordingly, it is possible to restore a used garment which is de-shaped, pilled, and frayed before treatment by re-shaping, de-pilling, and de-fraying of the garment, by treatment with the presently disclosed composition.

Applying the presently disclosed composition to a used, de-shaped garment may achieve re-shaping of the garment back to, or close to, its original shape. In other words, a reduction in size of the used, de-shaped garment may be obtained. In experiments performed under the presently disclosed conditions, it been shown that the presently disclosed composition achieves a reduction in size of the garment of from about 5% to about 20% of the size of the used, de-shaped garment before treatment.

The capacity of the presently disclosed composition of de-pilling of a surface of a garment includes removal of pills from the surface, wherein the surface of the used garment before treatment with the presently disclosed composition has a degree of pilling which ranges from very severe pilling to slight pilling, based on visual assessment according to ASTM International's standard scale of pilling (see Table 1 and FIG. 3).

In order to achieve de-pilling of a surface of a cellulose-containing used garment to such an extent that the degree of pilling of the surface can be reduced from very severe pilling before treatment to no pilling after treatment with the presently disclosed composition, the dosage of the cellulase preparation comprised by the composition may be at least about 3.5% of the weight of the cellulose-containing used garment to be treated. This corresponds, for example, to a dosage of at least 12 g of the presently disclosed powder composition when comprising 30% by weight of a cellulase preparation, per 100 g of cellulose-containing used garment to be treated, or in other words a dosage of the powder composition of at least 12% of the weight of the cellulose-containing used garment to be treated. It is to be understood that when the powder composition comprises a higher or lower percentage than 30% of the cellulase preparation, the dosage of the powder composition will differ accordingly, as seen in Table 4. Again, the degree of pilling before and after treatment is based on visual assessment according to ASTM International's standard scale of pilling. Further, a dosage of the cellulase preparation comprised by the composition of at least about 3.5% of the weight of the cellulose-containing used garment to be treated corresponds to a dosage of at least 16 ml of the presently disclosed liquid composition when comprising 15% by volume of a cellulase preparation, per 100 g of cellulose-containing used garment to be treated, or in other words a dosage of the liquid composition of at least 16% of the weight of the cellulose-containing used garment to be treated. It is to be understood that when the liquid composition comprises a higher or lower percentage than 15% of the cellulase preparation, the dosage of the composition will differ accordingly.

Applying the presently disclosed composition to a used garment which has frayed edges or parts, which are thicker and go through more abrasion or rubbing than the rest of the garment, may achieve de-fraying of the edges or parts. Such edges or parts as defined above include collars, cuffs, hems, plackets, etc. The capacity of de-fraying of such edges or parts of a used garment includes removal of frays from such edges or parts of the garment, wherein said edges or parts of the used garment before treatment with the presently disclosed composition have a degree of fraying which ranges from low fraying to severe fraying according to an internal scale of fraying used by the present inventor, as shown in FIG. 4. In order to achieve de-fraying of an edge or part of a cellulose-containing used garment to such an extent that the degree of fraying of the edge or part can be reduced from severe fraying before treatment to no fraying after treatment with the presently disclosed composition, the dosage of the cellulase preparation comprised by the composition may be at least about 3.5% of the weight of the cellulose-containing used garment to be treated. This corresponds, for example, to a dosage of at least 12 g of the presently disclosed powder composition when comprising 30% of a cellulase preparation, per 100 g of cellulose-containing used garment to be treated, or in other words a dosage of the powder composition of at least 12% of the weight of the cellulose-containing used garment to be treated. It is to be understood that when the composition comprises a higher or lower percentage than 30% of the cellulase preparation, the dosage of the composition will differ accordingly, as seen in Table 4. Further, this corresponds to a dosage of at least 16 g of the presently disclosed liquid composition when comprising 15% by volume of a cellulase preparation, per 100 g of cellulose-containing used garment to be treated, or in other words a dosage of the liquid composition of at least 16% of the weight of the cellulose-containing used garment to be treated. It is to be understood that when the liquid composition comprises a higher or lower percentage than 15% of the cellulase preparation, the dosage of the composition will differ accordingly.

The present disclosure provides a composition for use in restoration of a cellulose-containing used garment in a non-industrial laundry equipment selected from a domestic laundry equipment and a professional non-industrial equipment, said composition comprising:
a. from about 15% to about 60% of a cellulase preparation, such as, from about 15% to about 60% by weight, or from about 15% to about 60% by volume, of the cellulase preparation;
b. from about 30% to about 90% of a carrier, such as, from about 30% to about 60% by weight, or from about 70% to about 90% by volume, of the carrier;
c. from about 0.5% to about 10% of a buffering and/or sequestering agent, such as, from about 3% to about 9% by weight, or from about 0.5% to about 10% by volume, of the buffering and/or sequestering agent; and
d. optionally from about 10% to about 20% of a sequestering agent, such as from about 10% to about 20% by weight or from about 10% to about 20% by volume of a sequestering agent;
e. optionally from about 1% to about 8% of one or more surfactants, such as from about 1% to about 5% by weight of a first surfactant and/or from about 0.5% to about 1.5% by weight of a second surfactant, or from about 1% to about 5% by volume of a first surfactant and/or from about 0.5% to about 1.5% by volume of a second surfactant;
   provided that the percentages of (a)-(e) are either all by weight or all by volume.

More particularly, said composition may comprise:
a. from about 15% to about 60% by weight or by volume of the cellulase preparation, such as from about 20% to about 55%, from about 25% to about 50%, from about 30% to about 45%, or from about 35% to about 40%, by weight or by volume, such as about 15%, 20%, 25%, 30%, 35%, 40%, 45%, 50%, 55%, or 60% by weight or by volume of the cellulase preparation;
b. from about 30% to about 90% by weight or by volume of the carrier, such as from about 35% to about 85%, from about 40% to about 80%, from about 45% to about 75%, from about 50% to about 70%, or from about 55% to about 65%, by weight or by volume, or such as from about 30% to about 60% by weight, such as about 30%, 35%, 40%, 45%, 50%, 55%, or 60% by weight, or such as from about 70% to about 90% by volume, such as about 70%, 75%, 80%, 85%, or 90% by volume, of the carrier;
c. from about 0.5% to about 10% by weight or by volume of the buffering and/or sequestering agent, such as from about 1% to about 9%, from about 2% to about 8%, from about 3% to about 7%, from about 4% to about 6%, by weight or by volume, or such as from about 3% to about 9% by weight, such as about 3%, 4%, 5%, 6%, 7%, 8%, or 9% by weight, or such as from about 0.5% to about 10% by volume, such as about 0.5%, 0.75%, 1%, 2%, 3%, 4%, 5%, 6%, 7%, 8%, 9%, or 10% by volume, of the buffering and/or sequestering agent;
d. optionally from about 10% to about 20% by weight or by volume of the sequestering agent, such as from about 11% to about 19%, from about 12% to about 18%, from about 13% to about 17%, from about 14% to about 16%, by weight or by volume, such as about 10%, 11%, 12%, 13%, 14%, 15%, 16%, 17%, 18%, 19%, or 20% by weight or by volume of the sequestering agent;
e. optionally from about 1% to about 8% by weight or by volume of the one or more surfactants, such as from about 2% to about 7%, from about 3% to about 6%, from about 4% to about 5%, by weight or by volume of the one or more surfactants, or such as from about 1% to about 5% by weight or by volume of the first surfactant, such as about 1.0%, 1.5%, 2.0%, 2.5%, 3.0%, 3.5%, 4.0%, 4.5%, or 5.0% by weight or by volume of the first surfactant, and/or from about 0.5% to about 1.5% by weight or by volume of the second surfactant, such as about 0.5%, 0.6%, 0.7%, 0.8%, 0.9%, 1.0%, 1.1%, 1.2%, 1.3%, 1.4%, or 1.5% by weight or by volume of the second surfactant;
   provided that the percentages of (a)-(e) are either all by weight or all by volume.

The composition may be a powder, in which case the percentages of (a)-(e) above are all by weight.

Alternatively, the composition is a liquid, in which case the percentages of (a)-(e) above are all by volume.

For the powder composition and for the liquid composition, the cellulase preparation according to (a) above has the properties as described in detail elsewhere herein, for example in connection with the detailed description above of the use of a composition for restoring of a cellulose-containing used garment, said detailed description including a description of the cellulase preparation comprised by said composition.

For the powder composition, the carrier according to (b) above may be selected from a group consisting of sodium sulphate, sodium borate, and a combination thereof. Alternative names for sodium borate are Borax, sodium tetraborate decahydrate, sodium tetraborate, and disodium tetra borate.

For the powder composition, the buffering and/or sequestering agent according to (c) above may be selected from a group consisting of adipic acid, sodium citrate, sodium carbonate, sodium silicate, zeolite, sodium tripolyphosphate, and any combinations thereof.

For the powder composition, the sequestering agent according to (d) above may be selected from a group consisting of sodium citrate, sodium silicate, adipic acid, and any combinations thereof.

For the powder composition, the first surfactant according to (e) above may be selected from a group consisting of starch, cellulose gum (i.e., carboxymethyl cellulose), carboxymethyl inulin, and any combinations thereof.

For the powder composition, the second surfactant according to (e) above may be selected from a group consisting of ethoxylated fatty alcohol, lauryl alcohol ethoxylate, coconut diethanolamide, and any combinations thereof.

For the powder composition, any component according to (a) as specified above may be combined with any component according to (b), (c), (d), and (e) as specified above. Further, any component according to (b) as specified above may be combined with any component according to (a), (c), (d), and (e) as specified above. Also, any component according to (c) as specified above may be combined with any component according to (a), (b), (d), and (e) as specified above. Additionally, any component according to (d) as specified above may be combined with any component according to (a), (b), (c), and (e) as specified above. Also, any component according to (e) as specified above may be combined with any component according to (a), (b), (c), and (d) as specified above.

According to non-limiting examples, the powder composition may comprise:
a. from about 20% to about 50% by weight of the cellulase preparation, such as from about 20% to about 45%, from about 20% to about 40%, from about 25% to about 45%, from about 25% to about 40%, from about 25% to about 35%, from about 25% to about 30%, from about 30% to about 35%, or such as about 20%, 25%, 30%, 35%, 40%, 45%, or 50% by weight of the cellulase preparation;
b. from about 40% to about 50% by weight of the carrier, such as from about 41% to about 49%, from about 42% to about 48%, from about 43% to about 48%, from about 43% to about 47%, from about 44% to about 47%, from about 44% to about 46%, from about 45% to about 47%, or such as about 40%, 41%, 42%, 43%, 44%, 45%, 46%, 47%, 48%, 49%, or 50% by weight of the carrier, optionally wherein the carrier is selected from the group consisting of sodium sulphate, sodium borate, and a combination thereof;
c. from about 5% to about 7% by weight of the buffering and/or sequestering agent, such as from about 5.1% to about 6.9%, from about 5.2% to about 6.8%, from about 5.3% to about 6.7%, from about 5.4% to about 6.6%, from about 5.5% to about 6.5%, from about 5.6% to about 6.4%, from about 5.7% to about 6.3%, from about 5.8% to about 6.2%, from about 5.9% to about 6.1%, or such as about 5.0%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, or 7.0% by weight of the buffering and/or sequestering agent, optionally wherein the buffering and/or sequestering agent is selected from a group consisting of adipic acid, sodium citrate, sodium carbonate, sodium silicate, zeolite, sodium tripolyphosphate, and any combinations thereof;
d. from about 12% to about 17% by weight of the sequestering agent, such as from about 12.5% to about 16.5%, from about 13% to about 16%, from about 13% to about 15%, from about 13.5% to about 15.5%, from about 13.5% to about 15%, from about 13.5% to about 14.5%, from about 14% to about 15%, or such as about 12%, 12.5%, 13%, 13.5%, 14%, 14.5%, 15%, 15.5%, 16%, 16.5%, or 17% by weight of the sequestering agent, optionally wherein the sequestering agent is selected from a group consisting of sodium citrate, sodium silicate, adipic acid, and any combinations thereof;
e. from about 2% to about 4% by weight of the first surfactant, such as from about 2.1% to about 3.9%, from about 2.2% to about 3.8%, from about 2.3% to about 3.7%, from about 2.4% to about 3.6%, from about 2.5% to about 3.5%, from about 2.6% to about 3.4%, from about 2.7% to about 3.3%, from about 2.8% to about 3.2%, from about 2.9% to about 3.1%, or such as about 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, or 4.0% by weight of the first surfactant, optionally wherein the first surfactant is selected from a group consisting of starch, cellulose gum, carboxymethyl inulin, and any combinations thereof; and
f. from about 0.8% to about 1.2% by weight of the second surfactant, such as from about 0.85% to about 1.15%, from about 0.9% to about 1.1%, from about 0.95% to about 1.05%, or such as about 0.8%, 0.85%, 0.9%, 0.95%, 1.0%, 1.05%, 1.1%, 1.15%, or 1.2% by weight of the second surfactant, optionally wherein the second surfactant is selected from a group consisting of ethoxylated fatty alcohol, lauryl alcohol ethoxylate, coconut diethanolamide, and any combinations thereof.

According to non-limiting examples, the powder composition may comprise:
a. from about 20% to about 50% by weight of the cellulase preparation, such as from about 20% to about 45%, from about 20% to about 40%, from about 25% to about 45%, from about 25% to about 40%, from about 25% to about 35%, from about 25% to about 30%, from about 30% to about 35%, or such as about 20%, 25%, 30%, 35%, 40%, 45%, or 50% by weight of the cellulase preparation;
b. from about 40% to about 50% by weight of sodium sulphate, such as from about 41% to about 49%, from about 42% to about 48%, from about 43% to about 48%, from about 43% to about 47%, from about 44% to about 47%, from about 44% to about 46%, from about 45% to about 47%, or such as about 40%, 41%, 42%, 43%, 44%, 45%, 46%, 47%, 48%, 49%, or 50% by weight of sodium sulphate;
c. from about 5% to about 7% by weight of adipic acid, such as from about 5.1% to about 6.9%, from about 5.2% to about 6.8%, from about 5.3% to about 6.7%, from about 5.4% to about 6.6%, from about 5.5% to about 6.5%, from about 5.6% to about 6.4%, from about 5.7% to about 6.3%, from about 5.8% to about 6.2%, from about 5.9% to about 6.1%, or such as about 5.0%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, or 7.0% by weight of adipic acid;
d. from about 12% to about 17% by weight of sodium citrate, such as from about 12.5% to about 16.5%, from about 13% to about 16%, from about 13% to about 15%, from about 13.5% to about 15.5%, from about 13.5% to about 15%, from about 13.5% to about 14.5%, from about 14% to about 15%, or such as about 12%, 12.5%, 13%, 13.5%, 14%, 14.5%, 15%, 15.5%, 16%, 16.5%, or 17% by weight of sodium citrate;
e. from about 2% to about 4% by weight of starch, such as from about 2.1% to about 3.9%, from about 2.2% to about 3.8%, from about 2.3% to about 3.7%, from about 2.4% to about 3.6%, from about 2.5% to about 3.5%, from about 2.6% to about 3.4%, from about 2.7% to about 3.3%, from about 2.8% to about 3.2%, from about 2.9% to about 3.1%, or such as about 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, or 4.0% by weight of starch; and
f. from about 0.8% to about 1.2% by weight of ethoxylated fatty alcohol, such as from about 0.85% to about 1.15%, from about 0.9% to about 1.1%, from about 0.95% to about 1.05%, or such as about 0.8%, 0.85%, 0.9%, 0.95%, 1.0%, 1.05%, 1.1%, 1.15%, or 1.2% by weight of ethoxylated fatty alcohol.

According to non-limiting examples, the powder composition may comprise:
a) about 30% by weight of a cellulase preparation,
b) about 46% by weight of sodium sulphate as a carrier,
c) about 6% by weight of adipic acid, sodium citrate, sodium carbonate, sodium silicate, zeolite, sodium tripolyphosphate, or any combinations thereof, as a buffering agent and sequestering agent,
d) about 14% by weight of sodium citrate, sodium silicate, adipic acid, or any combinations thereof, as a sequestering agent,
e) about 3% by weight of starch, cellulose gum, carboxymethyl inulin, or any combinations thereof, as a first surfactant, and
f) about 1% by weight of ethoxylated fatty alcohol, lauryl alcohol ethoxylate, coconut diethanolamide, or any combinations thereof, as a second surfactant.

According to a non-limiting example, the powder composition may comprise:
a) about 30% by weight of a cellulase preparation,
b) about 46% by weight of sodium sulphate as a carrier,
c) about 6% by weight of adipic acid as a buffering agent and sequestering agent,
d) about 14% by weight of sodium citrate as a sequestering agent,
e) about 3% by weight of starch as a first surfactant, and
f) about 1% by weight of ethoxylated fatty alcohol as a second surfactant.

For the liquid composition, the carrier according to (b) above may be water.

For the liquid composition, the buffering and/or sequestering agent according to (c) above may be a buffering agent selected from a group consisting of sodium formate, sodium borate, propylene glycol, mono-ethanolamine, potassium oleate, calcium chloride, citric acid, and any combinations thereof.

According to non-limiting examples, the liquid composition may comprise:
a. from about 15% to about 50% by volume of the cellulase preparation, such as from about 15% to about 45%, from about 15% to about 40%, from about 15% to about 35%, from about 15% to about 30%, from about 15% to about 25%, from about 15% to about 20%, or such as about 15%, 16%, 17%, 18%, 19%, 20%, 21%, 22%, 23%, 24%, 25%, 30%, 35%, 40%, 45%, or 50% by volume of the cellulase preparation;
b. from about 70% to about 90% by volume of the carrier, such as from about 71% to about 89%, from about 72% to about 88%, from about 73% to about 87%, from about 74% to about 86%, from about 74% to about 85%, from about 74% to about 84%, from about 74.5% to about 83.5%, from about 75% to about 85%, from about 76% to about 84%, from about 77% to about 83%, or such as 70%, 71%, 72%, 73%, 74%, 75%, 76%, 77%, 78%, 79%, 80%, 81%, 82%, 83%, 84%, 85%, 86%, 87%, 88%, 89%, or 90% by volume of the carrier, optionally wherein the carrier is water;
c. from about 0.5% to about 10% by volume of the buffering agent, such as from about 0.75% to about 8%, from about 1% to about 7%, from about 1% to about 5%, or such as about 0.5%, 0.75%, 1%, 2%, 3%, 4%, 5%, 6%, 7%, 8%, 9%, or 10% by volume of the buffering agent, optionally wherein the buffering agent is selected from a group consisting of sodium formate, sodium borate, propylene glycol, mono-ethanolamine, potassium oleate, calcium chloride, citric acid, and any combinations thereof;
d. optionally from about 0.1% to about 1% by volume of a preservative agent, such as from about 0.2% to about 0.9%, from about 0.2% to about 0.8%, from about 0.3% to about 0.7%, from about 0.4% to about 0.6%, or such as about 0.1%, 0.2%, 0.3%, 0.4%, 0.5%, 0.6%, 0.7%, 0.8%, 0.9%, or 1% by volume of a preservative agent.

The liquid composition may optionally comprise a preservative agent according to (d) above. Non-limiting examples of water-soluble preservative agents commonly used in liquid detergents, and which may suitably be included in a liquid composition according to the present disclosure in order to prevent microbial growth in the composition, are as follows: Methylisothiazolinone, methylchloroisothiazolinone, sodium benzoate, dehydroacetic acid, bronopol, phenoxy ethanol, caprylyl glycol, EDTA, and Proxel™ GXL, i.e. 20% aqueous dipropylene glycol solution of 1,2-benzisothiazolin-3-one.

According to a non-limiting example, the liquid composition may comprise:
a) from about 15% to about 20% by volume of a cellulase preparation,
b) from about 74.5% to about 83.5% by volume of water as a carrier,
c) from about 1% to about 5% by volume of sodium formate as a buffering agent, and
d) about 0.5% by volume of 20% aqueous dipropylene glycol solution of 1,2-benzisothiazolin-3-one as a preservative agent.

According to a non-limiting example, the liquid composition may comprise:
a) about 15% by volume of a cellulase preparation,
b) about 83% by volume of water as a carrier,
c) about 1.5% by volume of sodium formate as a buffering agent, and
d) about 0.5% by volume of 20% aqueous dipropylene glycol solution of 1,2-benzisothiazolin-3-one as a preservative agent.

For the liquid composition, the component according to (a) as specified above may be combined with any component according to (b), (c), and optionally (d) as specified above. Further, any component according to (b) as specified above may be combined with any component according to (a), (c), and optionally (d) as specified above. Also, any component according to (c) as specified above may be combined with any component according to (a), (b), and optionally (d) as specified above. Additionally, any component according to (d) as specified above may be combined with any component according to (a), (b), and (c) as specified above. Further, any preservative agent commonly used in liquid detergents may be combined with any component according to (a), (b), and (c) as specified above.

As shown in the Examples herein, the powder composition as well as the liquid composition are capable of (i) restoring of a mechanical tension of a garment, thereby achieving a re-shaping of the garment, (ii) de-pilling of a surface of a garment, and (iii) de-fraying of a collar(s) and/or edge(s) of a garment.

The present disclosure further provides a method for restoring a cellulose-containing used garment, said method comprising:
a. Adding of a cellulose-containing used garment and a composition comprising from about 15% to about 60% of a cellulase preparation to a non-industrial laundry equipment selected from a domestic laundry equipment and a professional non-industrial equipment;
b. Washing of the garment in the presence of water and the composition, at a temperature of from about 20° C. to about 60° C., such as about 20° C., 30° C., 40° C., 50° C., or 60° C., for a time period of from about 60 minutes to about 240 minutes, such as from about 120 minutes to about 180 minutes, or such as about 60, 90, 120, 150, 180, 210, or 240 minutes, at a drum rotation speed of a minimum of 300 rpm, such as 400, 500, 600, 700, 800, 900, 1000, 1100, 1200, 1300, or 1400 rpm;
   wherein the restoring is selected from a group consisting of: (i) restoring of a mechanical tension of the garment, thereby achieving a re-shaping of the garment, (ii) de-pilling of a surface of the garment, and (iii) de-fraying of a collar(s) and/or edge(s) of the garment, and any combinations thereof.

In said method, the cellulase preparation, as described in more detail elsewhere herein, may be used at a dosage of at least about 3.5% of the weight of said cellulose-containing used garment. Such a dosage may contribute to the composition's capability of de-pilling of the surface of the garment from very severe pilling to no pilling based on visual assessment.

In the above-disclosed method, the cellulase preparation, as described in more detail elsewhere herein, may have a cellulase activity of at least about 171 ECU/g. Such an enzyme activity may contribute to the composition's capability of de-pilling of the surface of the garment from very severe pilling to no pilling based on visual assessment.

Preferably, the composition referred to in connection with the above-mentioned method for restoring a cellulose-containing used garment, is the composition as disclosed in detail elsewhere herein.

The cellulase preparation referred to in the above-mentioned method for restoring a cellulose-containing used garment, has the properties as described in detail elsewhere herein, for example in connection with the detailed description above of the use of a composition for restoring of a cellulose-containing used garment, said detailed description including a description of the cellulase preparation comprised by said composition.

Further, the restorative actions referred to in connection with the above-mentioned method for restoring a cellulose-containing used garment, are as disclosed in detail elsewhere herein.

Also, the dosage of the cellulase preparation referred to in connection with the above-mentioned method for restoring a cellulose-containing used garment, is as disclosed in detail elsewhere herein.

The above-disclosed method may further comprise one or more additional steps following step b, said one or more additional steps comprising:
c. deactivating of the cellulase preparation by draining of the water from the non-industrial laundry equipment; and/or
d. realigning of the fibres in the garment, such as by tumble drying or ironing of the garment.

More particularly, the presently disclosed method for restoring a cellulose-containing used garment may comprise a step c following step b, wherein step c comprises deactivating of the enzymes of the cellulase preparation. Step c comprises draining of the water from the non-industrial laundry equipment selected from a domestic laundry equipment and a professional non-industrial equipment. Together with the water, also a large part of the composition is removed from the laundry equipment. Further, when the water is drained, the temperature decreases and/or the pH decreases inside the laundry equipment still containing the garment. When the temperature and/or the pH is no longer within the optimal range for the enzymes, or even completely outside of the range of temperature and/or pH at which the enzymes are functional, any cellulase still remaining on the garment (or elsewhere inside the laundry equipment) becomes deactivated, completely, or at least partially. Thus, in the presently disclosed method there is no need to contact the garment with a cellulase inhibitor to inhibit the activity of the cellulase. Step c may comprise a centrifuging process to drain the water more efficiently. The time period of step c may be from about 5 minutes to about 20 minutes.

The presently disclosed method may further comprise a step d1 following step b, and possibly following step c where applicable, wherein step d1 comprises realigning of the fibres in the garment, such as by tumble drying or ironing of the garment. Preferably, step d1 comprises tumble drying of the garment at a temperature of from about 40° C. to about 100° C., such as from about 50° C. to about 90° C., such as from about 60° C. to about 80° C., such as about 40° C., 50° C., 60° C., 70° C., 80° C., 90° C., or 100° C., for a time period of from about 15 minutes to about 45 minutes, such as from about 20 minutes to about 40 minutes, such as about 30 minutes, at a drum rotation speed of a minimum of 400 rpm, such as 500, 600, 700, 800, 900, 1000, 1100, 1200, 1300, or 1400 rpm. Alternatively, step d1 comprises ironing of the garment for a time period of from about 1 minute to about 10 minutes, at a temperature which is from about 50° C., up to and including, but not exceeding, the maximum temperature endured by the fibres of which the garment is made. For example, cotton fibre normally endures a higher temperature of ironing than most types of synthetic fibres. For cotton fibre, it is possible to apply a temperature of ironing of up to and including about 90° C., while for some types of synthetic fibres, the temperature of ironing shall not exceed 60° C.

As an alternative to the above-mentioned step d1, the presently disclosed method may comprise a step d2 following the above-mentioned step b, and where applicable also following the above-mentioned step c, of the above-mentioned method for restoring a cellulose-containing used garment. Step d2 comprises rinsing or cleaning of the fibres of the garment. Such rinsing or cleaning of the fibres of the garment may be performed by running a rinse cycle (i.e., a rinse programme) or a wash cycle (i.e., a wash programme), in the non-industrial laundry equipment selected from a domestic laundry equipment and a professional non-industrial equipment, which was used for steps a and b, and step c where applicable, of the above-mentioned method. Such a step d2 may optionally include adding a detergent to the non-industrial laundry equipment selected from a domestic laundry equipment and a professional non-industrial equipment. The temperature of a rinse or wash cycle of step d2 may be from about 20° C. to about 40° C. The time period of step d2 may be from about 15 minutes to about 45 minutes, such as about 30 minutes.

Further encompassed by the present disclosure is the above-described method for restoring a cellulose-containing used garment, comprising the above-mentioned steps a, b, d2, and d1, in the order specified here. Also encompassed is the above-described method for restoring a cellulose-containing used garment, comprising the above-mentioned steps a, b, c, d2, and d1, in the order specified here.

FIG. 5 schematically depicts the presently disclosed method. In general, the presently disclosed method comprises at least two steps, i.e., steps a and b, and may further comprise one, two, or three additional steps, i.e., steps c, d1, and/or d2. An arrow drawn as a dashed line indicates that the step following that arrow is optional. This applies to steps c, d1, and d2. FIG. 5 further shows that either d1, or d2, or a combination of d2 followed by d1, may be performed, following directly after step b or after step c.

Step a: Add the cellulose-containing used garment(s) to be restored to the drum of a non-industrial washing machine, selected from a domestic washing machine and a professional non-industrial washing machine. Add presently disclosed composition in the main wash compartment (often marked with a “II”) of the detergent container of the washing machine. The dosage may be as described in detail elsewhere herein; see for example Table 4.

Step b: This washing step aims at removing protruding fibres from the used garment. A wash programme (alternatively called a wash cycle) including a temperature of from about 20° C. to about 60° C. should be selected, such as 20° C., 30° C., 40° C., 50° C., or 60° C. Not all of these temperatures may be available on the currently most common domestic washing machines. However, at least two or three temperature values within the range of from about 20° C. to about 60° C. are normally available on currently common domestic washing machines. A wash programme should be selected which is suitable for the type of fibres of the garments to be restored. For example, for garments made of cotton, a cotton wash cycle should be selected. For the cellulase preparation used in the examples herein, the preferred temperature is 40° C. since the cellulase activity is optimal at 40° C. The machine heats the water to the selected temperature and fills the drum with the water, after which the composition is automatically dosed into the drum and the machine starts the revolutions. The composition is dispersed in the water, the buffer agent in the composition creates and maintains a neutral pH (i.e., around pH 7) in the bath throughout the process, the selected temperature creates a conducive environment for the cellulase to become active. To make the cellulose hydrolysis process efficient, some form of mechanical agitation must be induced. In the domestic laundry equipment, the revolutions provided by drum rotation machine, or by an agitator in top loading machines, have proven effective. The length of the wash cycle should be at least 60 minutes, and as described in more detail above, which was found to be a sufficient time for the drum rotation to provide the required repeated mechanical agitation. Within the above-given suitable time interval for the washing step (i.e., step b), a most suitable time period may be chosen, which is dependent on garment condition, weight of garment, and dosage of composition. Suitable agitation speed during step b is from about 300 to about 1400 rpm, as described in more detail above.

The drum rotation serves two purposes. One is that it ensures that the composition in the water gets a repeated contact with the substrate (i.e., the garment), thereby making the protruding fibres readily accessible for the cellulase. The second function of the drum rotation is that it provides sufficient mechanical action to break the fibre's weakened linkages to the surface of the garment.

Step c: This step aims at deactivating or inactivating the cellulase. Once the wash cycle of step b is complete, the machine drains both water and the composition in step c. The absence of functional temperature and pH deactivates any cellulase remaining on the garments or elsewhere inside the washing machine. Thus, there is no need to contact the garment with a cellulase inhibitor to inhibit the activity of the cellulase. A centrifuging process then provides additional mechanical action and extracts additional water out of the garments at the end of the process. A drum rotation speed of from about 400 rpm to about 1400 rpm, such as from about 600 rpm to about 1400 rpm, such as about 400 rpm, 600 rpm, 800 rpm, 1000 rpm, 1200 rpm, or 1400 rpm, is suitable to apply in this step. A draining and/or centrifuging process in a domestic washing machine normally takes from about 5 to about 20 minutes. In the post-centrifugal state there may still be water in the garment as cellulosic fibres, especially cotton, have the tendency to retain water and to swell in the presence of water. Additionally, there is some amount of residual fibre stuck on the surface and stuck in the fabric structure.

Step d1: To remove the residual fibre, and to achieve a realignment and/or contraction of the fibres, the garment needs to be exposed to heat, preferably in the form of a tumble-drying process. In the tumble-drying process, the hot air removes any residual fibre, dries, and realigns or straightens the fibre structure. The temperature of the tumble dryer may be from about 40° C. to about 100° C., as described in more detail above. The time period for tumble drying may be from about 15 minutes to about 45 minutes, as described in more detail above. Within the above-given suitable time interval for tumble drying, a most suitable time period may be chosen, which is dependent mainly on the weight of garment. The drum rotation speed may be a minimum of 400 rpm. Alternatively, step d1 may comprise ironing of the garment, as described in more detail elsewhere herein. Once the fibrillation is removed from the deeper structure, it allows the fabric to return to its original state.

Step d2: To remove the residual fibre, a regular rinse or detergent wash may be performed. This may be sufficient treatment for some types of garments, for example for tightly woven fabrics. The rinse will only help in removing the residual fibre, but it may not provide the restoration of shape. Accordingly, step d2 is less suited than step d1 for a knitted fabric since a knitted fabric is often more heavily de-shaped than a tightly woven fabric. A suitable time interval and a suitable temperature interval for step d2 is mentioned further above.

As shown in the Examples herein, the herein disclosed method for restoring of a cellulose-containing used garment is capable of (i) restoring of a mechanical tension of a garment, thereby achieving a re-shaping of the garment, (ii) de-pilling of a surface of a garment, and (iii) de-fraying of a collar(s) and/or edge(s) of a garment.

The present disclosure further provides a kit of parts, comprising the presently disclosed composition as described in detail elsewhere herein and further comprising instructions for use of said composition for restoring of a cellulose-containing used garment in a non-industrial laundry equipment selected from a domestic laundry equipment and a professional non-industrial equipment, wherein the restoring is selected from a group consisting of: (i) restoring of a mechanical tension of the garment, thereby achieving a re-shaping of the garment, (ii) de-pilling of a surface of the garment, and (iii) de-fraying of a collar(s) and/or edge(s) of the garment, and any combinations thereof.

The instructions for use of said composition may comprise instructions for performing the presently disclosed method as described in detail elsewhere herein.

The herein disclosed kit of parts is capable of (i) restoring of a mechanical tension of a garment, thereby achieving a re-shaping of the garment, (ii) de-pilling of a surface of a garment, and (iii) de-fraying of a collar(s) and/or edge(s) of a garment.

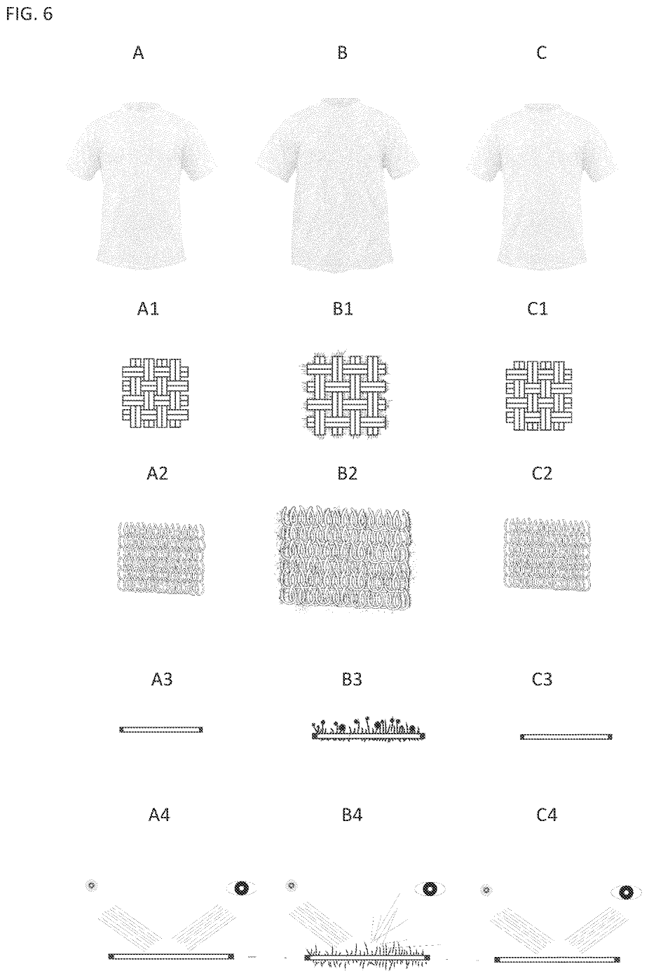

FIG. 6 demonstrates the overall functionality and effects of the presently disclosed process; the illustration is to be read from left to right. Sections A, B and C of FIG. 6 illustrate different stages of garment condition and characteristics. More particularly, section A illustrates characteristics of a new garment, section B represents characteristics of a used garment, which has not been subjected to treatment according to the present disclosure, and section C relates to characteristics of a used and restored garment, i.e., a used garment that has been restored in accordance with the present disclosure.

FIG. 6 (A) is a photograph of a new, white t-shirt as a non-limiting example of a new garment. FIG. 6 (A1) depicts the clear yarn structure of a woven, new garment while FIG. 6 (A2) illustrates clear yarn structure of a knitted, new garment. FIG. 6 (A3) schematically shows a smooth surface of a new garment, and FIG. 6 (A4) depicts the surface reflectance of a new garment.

After repeated use and laundering, the garment wears down, goes through fibrillation, becomes loose and pilled, as shown in section B of FIG. 6. More particularly, FIG. 6 (B) is a photograph of a used, de-shaped white t-shirt. FIG. 6 (B1) and FIG. 6 (B2) show the fibrillated yarn structure of a used woven garment and a used knitted garment, respectively. FIG. 6 (B3) schematically shows a fibrillated surface, comprising fuzz and pilling, and FIG. 6 (B4) depicts the surface reflectance of a used garment. The fibrillation prevents the fabric from returning to its original shape and impairs the surface reflectance.

Treatment of the used garment with a cellulase-containing composition as presently disclosed, results in restoration of characteristics of the used garment, as shown in section C of FIG. 6. More particularly, FIG. 6 (C) is a photograph of a used and restored white t-shirt, in which the mechanical tension has been restored. Thereby the t-shirt has been re-shaped; it has regained its original shape or nearly. FIG. 6 (C1) shows the clear yarn structure of a used and restored woven garment, while FIG. 6 (C2) shows the clear yarn structure of a used and restored knitted garment. FIG. 6 (C3) schematically shows the smooth surface of a used and restored garment, and FIG. 6 (C4) depicts the surface reflectance of a used and restored garment.

In summary, FIG. 6 illustrates that the presently disclosed composition, kit of parts, use and/or method results in restoration of several characteristics of a used garment, such as restoring of the mechanical tension of the garment, de-pilling of the surface of the garment, and restoring of the surface reflectance of the garment.

### EXPERIMENTAL SECTION

### Example 1: Powder Composition

A composition in the form of a powder (more particularly, a granulate or granulated powder) was prepared. The powder composition comprised:
a) 30% by weight of a cellulase preparation,
b) 46% by weight of sodium sulphate as a carrier,
c) 6% by weight of adipic acid as a buffering agent and sequestering agent,
d) 14% by weight of sodium citrate as a sequestering agent,
e) 3% by weight of starch as a first surfactant, and
f) 1% by weight of ethoxylated fatty alcohol as a second surfactant.

The cellulase preparation comprised by the composition was Mazyme (Aquitex, Portugal), which is a preparation of neutral cellulases. These enzymes are active already at 20° C. and up to at least 60° C. but their optimum activity is at about 40° C. The enzymes work at a pH of 5.5-8.0. The activity level of the enzymes in this cellulase preparation is 8200 CCU/g.

### Example 2: Liquid Composition

A composition in the form of a liquid was prepared. The liquid composition comprised:
a) 15% by volume of a cellulase preparation,
b) 83% by volume of water as a carrier,
c) 1.5% by volume of sodium formate as a buffering agent, and
d) 0.5% by volume of 20% aqueous dipropylene glycol solution of 1,2-benzisothiazolin-3-one as a preservative agent.

The cellulase preparation comprised by the liquid composition was Mazyme Liq (Aquitex, Portugal), which is a preparation of neutral cellulases. These enzymes are active already at 20° C. and up to at least 60° C. but their optimum activity is at about 40° C. The enzymes work at a pH of 4.5-7.5. The activity level of the enzymes in this cellulase preparation is 19500 CNU-LTC/g.

### Example 3: Restoration of Used Garments by Use of Powder Composition

The powder composition according to Example 1 was used for restoring of cellulose-containing used garments.

Sample Selection

The samples of garments selected for the trials were either personal samples or specifically bought from second-hand stores. The selection was done strategically to cover most aspects and types of garments that are relevant for treatment by the presently disclosed product.
Garment type: Woven shirts, knits, Jersey T-shirts, Denim
Fabric construction: The fabric constructions used included both woven, fine gauge jersey, heavy gauge knits
Fabric weight: The garment weights ranged from 70 grams/garment to 450 grams/garment.
Composition: A wide range of garments were mixed during the trials, including garments made of 100% cotton, cotton/polyester mix, cotton/linen mix, cotton/Lyocell mix, and cotton/viscose mix.
Perceived quality: The garments used for the experiments ranged from branded garments known for having good quality as well as those having lower price and lower quality materials.
Condition: The condition of the garments selected for the experiments ranged from slightly worn out to highly worn out.

The garments were selected from different consumers' used garments and there was no information available on the processes used to produce the garments tested.

Surface Appearance
Lab testing conditions:
   Samples of 10 cm×10 cm were cut out from the selected garments.
   The grade of pilling on the surface of the samples was ranked by a panel consisting of five persons based on their visual assessment of the fabrics in comparison to ASTM International's standard scale of pilling, which ranges from grade 1 to grade 5, where grade 5 corresponds to a clean surface with no fuzz or pilling, in which the fabric texture was clearly apparent. Grade 1 corresponds to very severe pilling and fuzz (see Table 1 and FIG. 3).
   The grade of fraying on edges or parts (as defined elsewhere herein) of the samples was ranked by a panel consisting of five persons based on their visual assessment of the fabrics in comparison to the inventor's internal standard of fraying, which ranges from grade 1 to grade 4, where grade 4 corresponds to no fraying of edges or parts. Grade 1 corresponds to severe fraying of edges or parts (see FIG. 4).
   At least one sample from each garment was treated with the presently disclosed composition comprising cellulase and at least one sample from each garment was used as control, i.e., was not treated with the presently disclosed composition comprising cellulase but was otherwise subjected to the same conditions as the treated sample.

Weight Loss
The weight loss of the samples was measured by weighing the samples before and after the enzyme treatment under 60% relative humidity for 24 h using Equation 1 below.

Weight loss %=[(Wm−Wd)/Wd]×100. (1)
Wd: weight (in grams) of the sample after treatment; Wm: weight (in grams) of the sample before treatment.

Laundry Equipment

The washing machine used for experimentation was a domestic washing machine, more particularly an Electrolux Perfect care 700 automatic machine (Electrolux, Sweden).

Method Conditions

The method was performed as generally described above in connection with FIG. 5.

The dosage of the powder composition added in step a of the method was at least about 12 g of the powder composition per 100 g of cellulose-containing garments, corresponding to a dosage of cellulase preparation of at least about 3.5% on the weight of fabric.

During step b, the temperatures chosen for the experiments were 40° C. and 60° C., respectively, and the pH was maintained around 7, i.e., within the optimal temperature and pH intervals for the enzymes of the cellulase preparation comprised by the composition. Different wash cycles (i.e., different wash programmes) were used for different garments, depending on the types of fibres of each garment (e.g., wash cycles for cotton, synthetic, and mixed fibres, respectively).

Results and Discussion

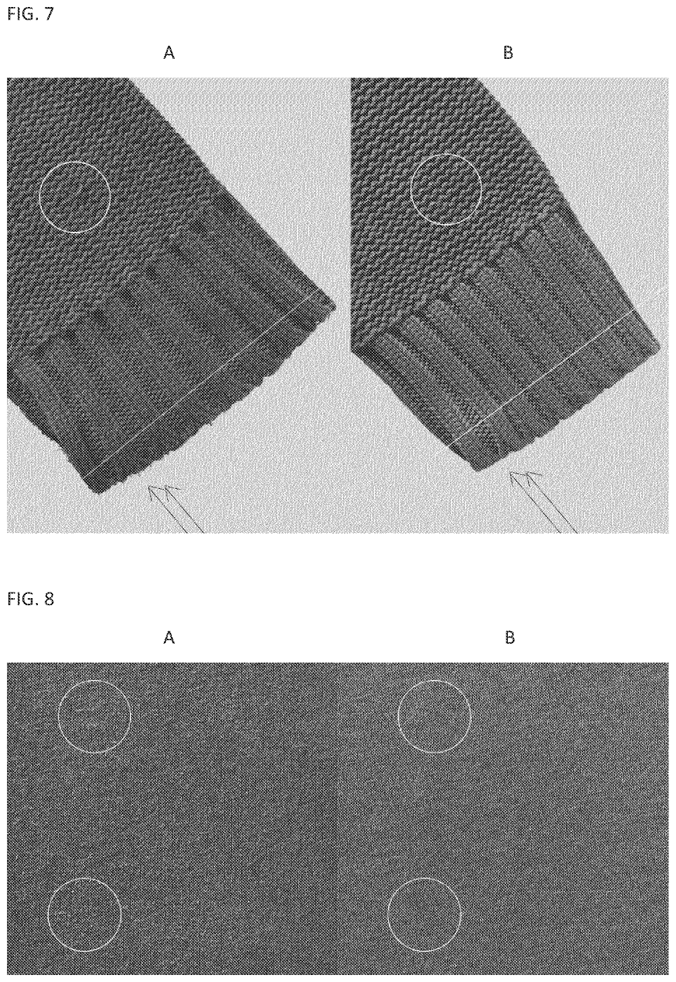

The results of applying the presently disclosed powder composition and method are shown in the photographs of FIGS. 7, 8, and 9.

FIG. 7 shows the before and after results of a 100% cotton heavy gauge knitted garment. The garment had a pilling of grade 3, with fraying on the cuff edge (marked by red oval, dull shade, and loose shape before treatment. After application of the presently disclosed composition and method, the surface appears clean, colours appear brighter, the cuff has resumed its original shape and frays have been removed. After drying the garment loses much of its moisture content and thus it should be allowed 24 hours to regain moisture content. The measurement on the cuff and the sleeve was taken before and after the restoration, the width of the bottom edge of the cuff was 15 cm before restoration, while after restoration with moisture regained the bottom edge of the cuff was measured to be 11 cm. In general, restoration of shape in terms of length or width measurements will vary across different garments based on their state, structure, and construction.

FIG. 8 shows the before and after results of a 100% cotton jersey garment. The garment had a pilling of grade 1 before treatment. After use of the presently disclosed composition, the pilling has decreased, and the structural clarity has increased.

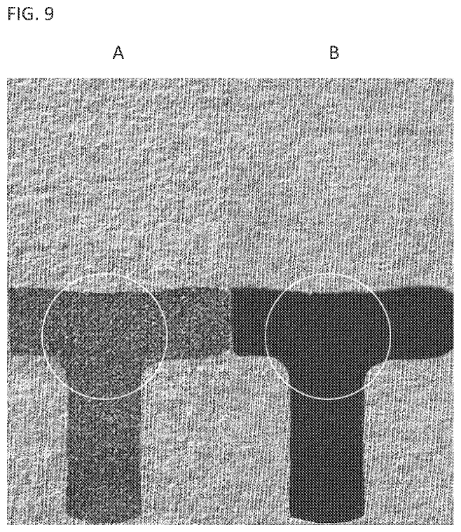

FIG. 9 shows the results of restoration on the print area of a garment having a pilling rating of 1 (i.e., grade 1) before restoration. After the restoration process, the print becomes clearer and the surface becomes clean and smooth, thanks to the de-pilling effects of the composition and the method.

### Example 4: Restoration of Used Garments by Use of Liquid Composition

The liquid composition according to Example 2 was used for restoring of cellulose-containing used garments.

In the present Example, all samples, equipment, method conditions and test conditions were identical to those of Example 3, except that the dosage of the liquid composition added in step a of the method was at least 16 g of liquid composition per 100 g of cellulose-containing garments, corresponding to a dosage of cellulase preparation of at least about 3.5% on the weight of fabric.

Results similar to those described in Example 3 were obtained by treatment with the liquid composition.

It is to be understood that the present disclosure is not restricted to the above-described exemplifying embodiments thereof and that several conceivable modifications of the present disclosure are possible within the scope of the following claims.

### REFERENCES

Annis, P. A. (2005, September). Surface Wear Analysis of Fabrics. Retrieved from ASTM: https://www.astm.org/SNEWS/SEPTEMBER_2005/annis_sep05.html
Elder, H. M. (1978). Wear of textiles. Journal of Consumer Studies and Home Economics, 2(1): 1-13.
Fan, J. and Hunter, L. (2009). Pilling of fabrics and garments. In Engineering apparel fabrics and garments, 1st edition, pp. 71-84.
Marjan Barakzehi et al. (2016). Effect of the fabric color on the visual perception of pilling. International Journal of Clothing science and technology, 28(5): 612-623.
Novozymes (2021). Novozymes BioPolishing. Retrieved Jan. 7, 2021, from https://www.novozymes.com/en/advance-your-business/textiles/biopolishing/.
Vigneswaran C. et al. (2011). Biovision in Textile Wet Processing Industry-Technological Challenges. Journal of Textile and Apparel, Technology and Management, 7(1): 1-13.

1. (canceled)

2. A composition for use in restoration of a cellulose-containing used garment in a non-industrial laundry equipment selected from a domestic laundry equipment and a professional non-industrial equipment, said composition comprising:
a. from about 15% to about 60% by weight of a cellulase preparation;
b. from about 30% to about 60% by weight of a carrier;
c. from about 3% to about 9% by weight of a buffering and/or sequestering agent;
d. optionally from about 10% to about 20% by weight of a sequestering agent;
optionally from about 1% to about 5% by weight of a first surfactant and/or from about 0.5% to about 1.5% by weight of a second surfactant.

3. The composition according to claim 2, wherein the composition is a powder.

4. The composition according to claim 3, wherein the carrier is selected from a group consisting of sodium sulphate, sodium borate, and any combinations thereof.

5. The composition according to claim 3, wherein the buffering and/or sequestering agent is selected from a group consisting of adipic acid, sodium citrate, sodium carbonate, sodium silicate, zeolite, sodium tripolyphosphate, and any combinations thereof.

6. The composition according to claim 3, wherein the sequestering agent according to claim 2(d) is selected from the group consisting of sodium citrate, sodium silicate, adipic acid, and any combinations thereof.

7. The composition according to claim 3, wherein the first surfactant is selected from a group consisting of starch, cellulose gum, carboxymethyl inulin, and any combinations thereof.

8. The composition according to claim 3, wherein the second surfactant is selected from the group consisting of ethoxylated fatty alcohol, lauryl alcohol ethoxylate, coconut diethanolamide, and any combinations thereof.

9. The composition according to claim 3, comprising:
a. from about 20% to about 50% by weight of the cellulase preparation;
b. from about 40% to about 50% by weight of the carrier wherein the carrier is sodium sulphate;
c. from about 5% to about 7% by weight of an adipic acid buffering/sequestration agent;
d. from about 12% to about 17% by weight of a sodium citrate buffering/sequestration agent;
e. from about 2% to about 4% by weight of a starch first surfactant; and
f. from about 0.8% to about 1.2% by weight of an ethoxylated fatty alcohol second surfactant.

10. (canceled)

11. (canceled)

12. A method for restoring a cellulose-containing used garment, said method comprising:
a. Adding a cellulose-containing used garment and a composition comprising from about 15% to about 60% of a cellulase preparation to a non-industrial laundry equipment selected from a domestic laundry equipment and a professional non-industrial equipment;
b. Washing the garment in the presence of water and the composition, at a temperature of from about 20° C. to about 60° C., for a time period of from about 60 minutes to about 240 minutes, at a drum rotation speed of a minimum of 300 rpm;
wherein the restoring is selected from a group consisting of: (i) restoring of a mechanical tension of the garment, thereby achieving a re-shaping of the garment, (ii) de-pilling of a surface of the garment, and (iii) de-fraying of a collar(s) and/or edge(s) of the garment, and any combinations thereof.

13. The method according to claim 12, further comprising one or more additional steps following step b, said one or more additional steps comprising:
a. deactivating of the cellulase preparation by draining of the water from the non-industrial laundry equipment; and/or
b. realigning the fibres in the garment, such as by tumble drying or ironing the garment.

14. A kit of parts comprising the composition according to claim 2 and instructions for use of said composition for restoring of a cellulose-containing used garment in a non-industrial laundry equipment selected from a domestic laundry equipment and a professional non-industrial equipment, wherein the restoring is selected from a group consisting of: (i) restoring of a mechanical tension of the garment, thereby achieving a re-shaping of the garment, (ii) de-pilling of a surface of the garment, and (iii) de-fraying of a collar(s) and/or edge(s) of the garment, and any combinations thereof.

15. The kit of parts according to claim 14, wherein the instructions for use comprise instructions for performing a method comprising:
a. adding a cellulose-containing used garment and a composition comprising from about 15% to about 60% of a cellulase preparation to a non-industrial laundry equipment selected from a domestic laundry equipment and a professional non-industrial equipment;
b. washing the garment in the presence of water and the composition, at a temperature of from about 20° C. to about 60° C., for a time period of from about 60 minutes to about 240 minutes, at a drum rotation speed of a minimum of 300 rpm;
wherein the restoring is selected from a group consisting of: (i) restoring of a mechanical tension of the garment, thereby achieving a re-shaping of the garment, (ii) de-pilling of a surface of the garment, and (iii) de-fraying of a collar(s) and/or edge(s) of the garment, and any combinations thereof.

16. A composition for use in restoration of a cellulose-containing used garment in a non-industrial laundry equipment selected from a domestic laundry equipment and a professional non-industrial equipment, said composition comprising:
a. from about 15% to about 60% by volume, of a cellulase preparation;
b. from about 70% to about 90% by volume, of a carrier;
c. from about 0.5% to about 10% by volume, of a buffering and/or sequestering agent;
d. optionally from about 10% to about 20% by volume of a sequestering agent; and
e. optionally from about 1% to about 5% by volume of a first surfactant and/or from about 0.5% to about 1.5% by volume of a second surfactant.

17. The composition of claim 16 further comprising 0.1% to about 1% by volume of a preservative agent, wherein the content of the cellulase preparation is from 15% to about 50% by volume, the content of the carrier is from about 70% to about 90% by volume, and optionally the carrier is water, the content of the buffering and/or sequestering agent is from 0.5% to about 10% by volume wherein the buffering and/or sequestering agent is selected from a group consisting of sodium formate, sodium borate, propylene glycol, mono-ethanolamine, potassium oleate, calcium chloride, citric acid and any combinations thereof.

18. The method of claim 12 wherein the washing of the garment is for a time period of 120 minutes to 180 minutes.

19. The method of claim 13 wherein the tumble drying is conducted at a temperature of from about 40 C to about 100 C for a time period from about 15 minutes to 45 minutes at a minimum drum rotation speed of 400 rpm.
